(19) United States
(12) Patent Application Publication
(10) Pub. No.: US 2025/0351033 A1
(43) Pub. Date: Nov. 13, 2025

(54) METHOD AND APPARATUS FOR HANDOVER USING ARTIFICIAL INTELLIGENCE IN WIRELESS COMMUNICATION SYSTEM

(71) Applicant: Samsung Electronics Co., Ltd., Suwon-si (KR)

(72) Inventors: Seungbeom JEONG, Suwon-si (KR); Taeseop LEE, Suwon-si (KR)

(21) Appl. No.: 19/202,540

(22) Filed: May 8, 2025

(30) Foreign Application Priority Data
May 9, 2024 (KR) 10-2024-0061217

(51) Int. Cl. H04W 36/00; H04L 41/16

(52) U.S. Cl. CPC H04W 36/008357; H04L 41/16; H04W 36/0058

(57) ABSTRACT

The disclosure relates to a 5th generation (5G) or 6th generation (6G) communication system for supporting a higher data transmission rate. A method performed by a terminal in a wireless communication system is provided. The method includes receiving, from a base station, first information on a configuration for a prediction, based on the first information, performing the prediction, transmitting, to the base station, second information on the prediction, and receiving, from the base station, third information on a target cell, wherein the second information is used for determining a timing associated with a handover.

### CROSS-REFERENCE TO RELATED APPLICATION(S)

This application is based on and claims priority under 35 U.S.C. § 119(a) of a Korean patent application number 10-2024-0061217, filed on May 9, 2024, in the Korean Intellectual Property Office, the disclosure of which is incorporated by reference herein in its entirety.

### BACKGROUND

### 1. Field

The disclosure relates to operations of a terminal and a base station associated with handover in a wireless communication system. More particularly, the disclosure relates to a method and an apparatus for improving a handover process, using an artificial intelligence model.

### 2. Description of Related Art

5th generation (5G) mobile communication technologies define broad frequency bands such that high transmission rates and new services are possible, and can be implemented not only in “Sub 6 GHz” bands, such as 3.5 GHZ, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eM BB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

In performing a handover, in order to address unintended issues, including handover failure, a radio link failure (RLF), or throughput loss, an embodiment for carrying out a handover based on an artificial intelligence model or related algorithms may be considered.

Aspects of the disclosure are to address at least the above-mentioned problems and/or disadvantages and to provide at least the advantages described below. Accordingly, an aspect of the disclosure is to provide a method and an apparatus for improving a handover process, using an artificial intelligence model.

Additional aspects will be set forth in part in the description which follows and, in part, will be apparent from the description, or may be learned by practice of the presented embodiments.

In accordance with an aspect of the disclosure, a method performed by a terminal is provided. The method includes receiving, from a base station, first information on a configuration for a prediction, based on the first information, performing the prediction, transmitting, to the base station, second information on the prediction, and receiving, from the base station, third information on a target cell, wherein the second information is used for determining a timing associated with a handover.

According to an embodiment of the disclosure, the first information includes at least one of information on a time associated with the prediction, information on at least one interval, information on at least one condition, information on a number of the prediction, or information on at least one cell.

According to an embodiment of the disclosure, the second information includes at least one of prediction information associated with a radio resource management (RRM), prediction information on a probability, prediction information on a parameter associated with an interval or the time, prediction information on the at least one cell, or information on the timing associated with the handover.

According to an embodiment of the disclosure, the performing the prediction includes identifying whether at least one condition is satisfied, and performing the prediction on at least one cell that satisfies the at least one condition.

According to an embodiment of the disclosure, the method further includes transmitting, to the base station, fourth information on a capability associated with the prediction, wherein the prediction includes an artificial intelligence (AI)/machine learning (ML) prediction.

In accordance with another aspect of the disclosure, a method performed by a base station is provided. The method includes transmitting, to a terminal, first information on a configuration for a prediction, receiving, from the terminal, second information on the prediction, based on the second information, identifying at least one of a target cell or a timing associated with a handover, and transmitting, to the terminal, third information on the target cell, wherein the prediction is performed by the terminal based on the first information, and wherein the second information is used for determining the timing associated with the handover.

In accordance with another aspect of the disclosure, a terminal is provided. The terminal includes at least one transceiver; at least one processor communicatively coupled to the at least one transceiver; and at least one memory, communicatively coupled to the at least one processor, storing instructions executable by the at least one processor individually or in any combination to cause the terminal to receive, from a base station, first information on a configuration for a prediction, based on the first information, perform the prediction, transmit, to the base station, second information on the prediction, and receive, from the base station, third information on a target cell, wherein the second information is used for determining a timing associated with a handover.

In accordance with another aspect of the disclosure, a base station is provided. The base station includes at least one transceiver; at least one processor communicatively coupled to the at least one transceiver; and at least one memory, communicatively coupled to the at least one processor, storing instructions executable by the at least one processor individually or in any combination to cause the base station to transmit, to a terminal, first information on a configuration for a prediction, receive, from the terminal, second information on the prediction, based on the second information, identify at least one of a target cell or a timing associated with a handover, and transmit, to the terminal, third information on the target cell, wherein the prediction is performed by the terminal based on the first information, and wherein the second information is used for determining the timing associated with the handover.

According to an embodiment of the disclosure, a terminal may more effectively perform a handover process by using an artificial intelligence model.

According to an embodiment of the disclosure, via information predicted by a terminal in association with an artificial intelligence, a base station may more effectively indicate a handover or perform a process related thereto.

In accordance with another aspect of the disclosure, at least one processor, of a terminal, configured to individually or collectively execute instructions stored in memory to cause operations to be performed, is provided. The operations include receiving, from a base station, first information on a configuration for a prediction, based on the first information, performing the prediction, transmitting, to the base station, second information on the prediction, and receiving, from the base station, third information on a target cell, wherein the second information is used for determining a timing associated with a handover.

In accordance with another aspect of the disclosure, one or more non-transitory computer-readable storage media storing computer-executable instructions that, when executed by at least one processor of a terminal individually or collectively, cause the terminal to perform operations, is provided. The operations include receiving, from a base station, first information on a configuration for a prediction, based on the first information, performing the prediction, transmitting, to the base station, second information on the prediction, and receiving, from the base station, third information on a target cell, wherein the second information is used for determining a timing associated with a handover.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a wireless communication system according to an embodiment of the disclosure;

FIG. 2 is a diagram for illustrating radio access state transition of a user equipment (UE) in a wireless communication transition according to an embodiment of the disclosure;

FIG. 3 is a flowchart illustrating a process in which a UE performs cell measurement and reporting operations according to an embodiment of the disclosure;

FIG. 4 is a diagram for illustrating an operation in which a UE reports a cell measurement result when a specific condition is satisfied according to an embodiment of the disclosure;

FIG. 5 is a diagram illustrating input information (Input) and output information (Output) of an artificial intelligence model used by a UE according to an embodiment of the disclosure;

FIG. 6 is a diagram illustrating a process for a handover between a UE and a base station according to an embodiment of the disclosure;

FIG. 7A is a diagram illustrating a process for performing a prediction-based handover between a UE and a base station according to an embodiment of the disclosure;

FIG. 7B is a diagram illustrating a process for performing a prediction-based handover between a UE and a base station according to an embodiment of the disclosure;

FIG. 8A is a diagram illustrating a process for performing a prediction-based handover between a UE and a base station according to an embodiment of the disclosure;

FIG. 8B is a diagram illustrating a process for performing a prediction-based handover between a UE and a base station according to an embodiment of the disclosure;

FIG. 9 illustrates a structure of a UE according to an embodiment of the disclosure; and

FIG. 10 illustrates a structure of a base station according to an embodiment of the disclosure.

The same reference numerals are used to represent the same elements throughout the drawings.

### DETAILED DESCRIPTION

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the disclosure, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (A SIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services.

In the following description of the disclosure, terms and names defined in 5GS and NR standards, which are the standards specified by the 3rd generation partnership project (3GPP) group, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards) or 3GPP 5G advanced standards.

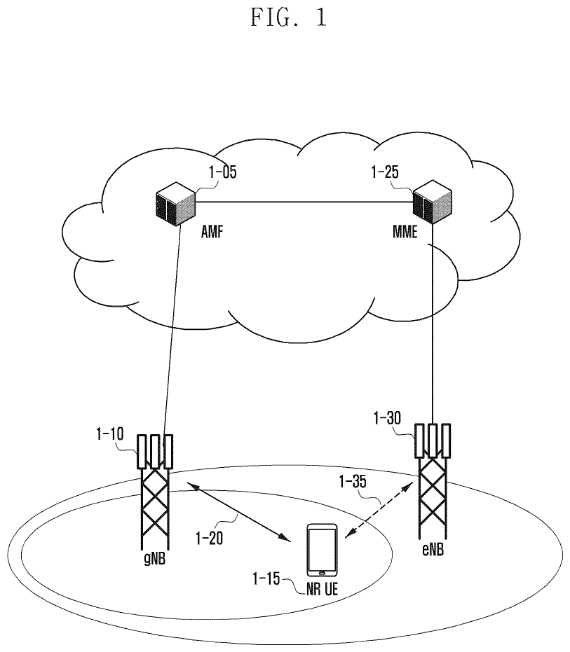

FIG. 1 illustrates a structure of a wireless communication system according to an embodiment of the disclosure.

Referring to FIG. 1, as illustrated therein, a radio access network of a mobile communication system (new radio, NR) according to an embodiment of the disclosure may include a base station (next generation Node B, hereinafter gNB) 1-10 and an access and mobility management function (AMF) (or new radio core network (CN)) 1-05. A user terminal (new radio user equipment, hereinafter NR UE or NR terminal) 1-15 may access an external network via the gNB 1-10 and the AMF 1-05. The mobile communication system of the disclosure may be a next generation wireless mobile communication system, and the gNB may be a next generation radio base station.

In FIG. 1, the gNB 1-10 may correspond to an evolved node B (eNB) 1-30 of an LTE system of the related art. The gNB is connected to the NR UE 1-15 through a radio channel 1-20 and may provide outstanding services as compared to a node B of the related art. In the next generation wireless mobile communication system according to an embodiment of the disclosure, since all user traffic is serviced through a shared channel, a device that collects state information, such as buffer statuses, available transmit power states, and channel states of UEs, and performs scheduling accordingly is required, and the gNB 1-10 may serve as the device. In general, one gNB may control multiple cells. In order to implement ultrahigh-speed data transfer beyond the current LTE, the next generation wireless mobile communication system may provide a wider bandwidth than the existing maximum bandwidth, may employ an orthogonal frequency division multiplexing (hereinafter referred to as orthogonal frequency division multiplexing (OFDM)) as a radio access technology, and may additionally integrate a beamforming technology therewith. Furthermore, the next generation wireless mobile communication system may employ an adaptive modulation & coding (hereinafter referred to as AMC) scheme for determining a modulation scheme and a channel coding rate according to a channel state of a UE.

The AMF 1-05 may perform functions, such as mobility support, bearer configuration, and QoS configuration. The AMF 1-05 is a device responsible for various control functions as well as a mobility management function for a UE, and may be connected to multiple base stations.

In addition, the mobile communication system according to an embodiment of the disclosure may interwork with the existing LTE system, and the AMF 1-05 may be connected to a mobility management entity (MME) 1-25 via a network interface. The MME 1-25 may be connected to the eNB 1-30 that is an existing base station. The NR UE 1-15 supporting LTE-NR dual connectivity may transmit/receive data while maintaining connections to both the gNB 1-10 through radio channel 1-20 and the eNB 1-30 through a radio channel 1-35.

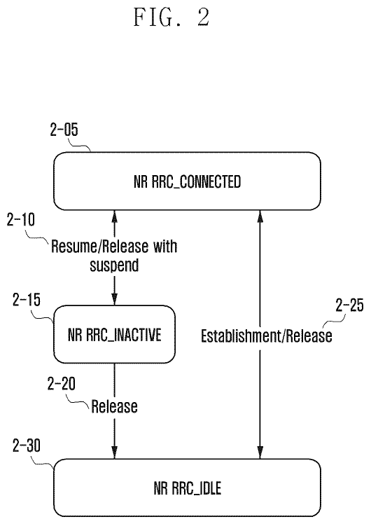

FIG. 2 is a diagram for illustrating radio access state transition of a UE in a wireless communication transition according to an embodiment of the disclosure.

Referring to FIG. 2, in the wireless communication system according to an embodiment of the disclosure, a UE may have three types of radio resource control (RRC) states or RRC modes. A connected mode (RRC-CONNECTED) 2-05 may correspond to a radio access state in which the UE may transmit and receive data. A standby mode (RRC-number or IDLE) 2-30 may correspond to a radio access state in which the UE monitors whether paging is transmitted to itself. The two modes (the connected mode and the standby mode) correspond to radio access states applicable also to the LTE system, and the same technical particulars as those of the LTE system may be applicable thereto. A wireless communication system according to an embodiment of the disclosure may be a next-generation mobile communication system.

In a wireless communication system according to an embodiment of the disclosure, an inactive radio access state (RRC_INACTIVE) 2-15 may be defined. In the inactive radio access state, UE context is maintained in a base station and the UE, and radio access network (RAN)-based paging may be supported. The inactive radio access state may have the following features:
Cell re-selection mobility;
CN-NR RAN connection (both control plane/user plane (C/U-planes)) has been established for UE;
UE access stratum (AS) context is stored in at least one gNB and the UE;
Paging is initiated by NR RAN;
RAN-based notification area is managed by NR RAN; and
NR RAN knows the RAN-based notification area which the UE belongs to.

A UE in an inactive radio access state according to an embodiment of the disclosure may switch its state to a connected mode or a standby mode by using a specific process. The switching 2-10 between the connected mode and the standby mode may be performed via a process of “resume” or “release with suspend”. For example, the UE may switch 2-10 its mode from the inactive mode to the connected mode according to the process of resume, and may switch 2-10 from the connected mode to the inactive mode by receiving a release message including suspend configuration information. This process is performed via transmission and reception of one or more RRC messages between the UE and the base station, and may include one or more operations. Further, via a process of release after resume, the UE may switch 2-20 its mode from the inactive mode to the standby mode. The switching 2-25 between the connected mode and the standby mode may follow the existing LTE technologies. For example, switching between the modes may be achieved via a process of establishment or release.

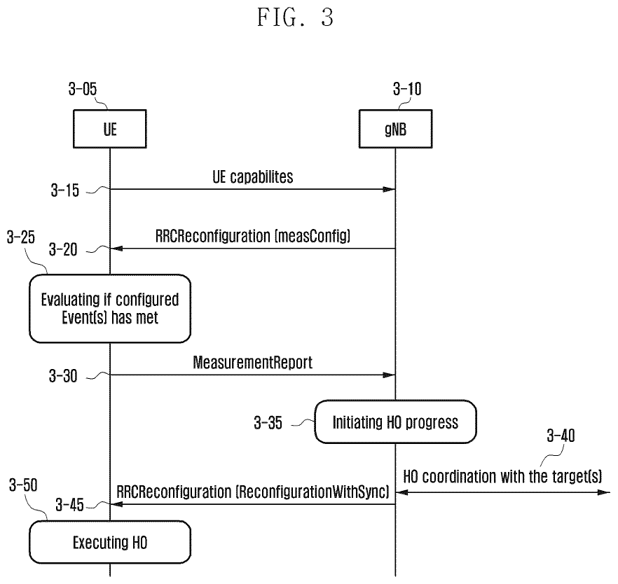

FIG. 3 is a flowchart illustrating a process in which a UE performs cell measurement and reporting operations according to an embodiment of the disclosure.

Referring to FIG. 1, according to an embodiment of the disclosure, in operation 3-15, a UE 3-05 may report its capability information to a base station 3-10. In operation 3-20, the base station 3-10 may transmit a message (e.g., RRC Reconfiguration message) including configuration information (e.g., measConfig IE) related to a cell measurement operation to the UE 3-05.

According to an embodiment of the disclosure, the configuration information (e.g., measConfig IE) may include information required for reporting a result measured by the UE 3-05 to the base station 3-10, according to a measurement report type (e.g., periodical, event-triggered or event-triggered periodical). For example, for “event-triggered” or “event-triggered periodical”, when a specific event configured based on the configuration information (e.g., measConfig IE) is satisfied, the UE 3-05 may report a predetermined measurement result. For example, the following events may be configured in the NR system.
Event(s) related to intra-/inter-RAT measurements are as shown in Table 1 below.

TABLE 1
Event A1: Serving becomes better than absolute threshold;
Event A2: Serving becomes worse than absolute threshold;
Event A3: Neighbor becomes amount of offset better than PCell/PSCell;
Event A4: Neighbor becomes better than absolute threshold;
Event A5: PCell/PSCell becomes worse than absolute threshold1 AND
Neighbor/SCell becomes better than another absolute threshold2;
Event A6: Neighbor becomes amount of offset better than SCell;
Event D1: Distance between UE and a reference location
referenceLocation1 becomes larger than configured threshold
distanceThreshFromReference1 and distance between UE and a reference
location referenceLocation2 becomes shorter than configured threshold
distanceThreshFromReference2;
Event B1: Neighbor becomes better than absolute threshold; and
Event B2: PCell becomes worse than absolute threshold1 AND Neighbor
becomes better than another absolute threshold2.

Similar to conditional measurement reporting, when a specific event is satisfied also in a conditional handover, the UE 3-05 may perform handover according to conditional handover configuration information. Event(s) related to a conditional handover are as shown in Table 2 below.

TABLE 2
CondEvent A3: Conditional reconfiguration candidate becomes amount of
offset better than PCell/PSCell;
CondEvent A4: Conditional reconfiguration candidate becomes better than
absolute threshold;
CondEvent A5: PCell/PSCell becomes worse than absolute threshold1
AND Conditional reconfiguration candidate becomes better than
another absolute threshold2;
CondEvent D1: Distance between UE and a reference location
referenceLocation1 becomes larger than configured threshold
distanceThreshFromReference1 and distance between UE and a reference
location referenceLocation2 of conditional reconfiguration candidate
becomes shorter than configured threshold
distanceThreshFromReference2;
and
CondEvent T1: Time measured at UE becomes more than configured
threshold t1-Threshold but is less than t1-Threshold + duration.

When a specific event is satisfied in a (sidelink) relay, the UE 3-05 may perform a predetermined operation. Event(s) related to the relay are as shown in Table 3 below.

TABLE 3
Event X1: Serving L2 U2N Relay UE becomes worse than absolute
threshold1 AND NR Cell becomes better than another absolute threshold2;
Event X2: Serving L2 U2N Relay UE becomes worse than absolute
threshold;
Event Y1: PCell becomes worse than absolute threshold1 AND candidate
L2 U2N Relay UE becomes better than another absolute threshold2; and
Event Y 2: Candidate L2 U2N Relay UE becomes better than absolute
threshold.

For NR-unlicensed (NR-U), when a specific event is satisfied, the UE 3-05 may perform a predetermined operation. Event(s) related to NR-U are as shown in Table 4 below.

TABLE 4

Event I1: Interference becomes higher than absolute threshold.

In operation 3-25, the UE 3-05 may evaluate whether the configured events are satisfied. For example, if the events described above are continuously satisfied with the predetermined conditions for a predetermined time period (time-to-trigger), the UE 3-05 may consider that the events are satisfied. In operation 3-30, the UE 3-05 may report a message (e.g., MeasurementReport message) including a measurement result to the base station 3-10 when the configured condition is satisfied. Alternatively, the UE 3-05 may perform a predetermined operation corresponding to the condition, e.g., a conditional handover.

The base station 3-10 having received the measurement result from the UE 3-05 may use the measurement result for a predetermined purpose. For example, in operation 3-35, the base station 3-10 may determine whether to trigger a handover (HO) of the UE 3-05. In operation 3-40, if triggering a handover, the station 3-10 may request handover from target cell(s). In operation 3-45, the base station 3-10 may transmit, to the UE 3-05, handover configuration information configured based on predetermined configuration information received from the target cell(s). In operation 3-50, the U E 3-05 having received the handover configuration information may perform a handover.

Some of the operations or stages may be omitted and may be performed with other operations.

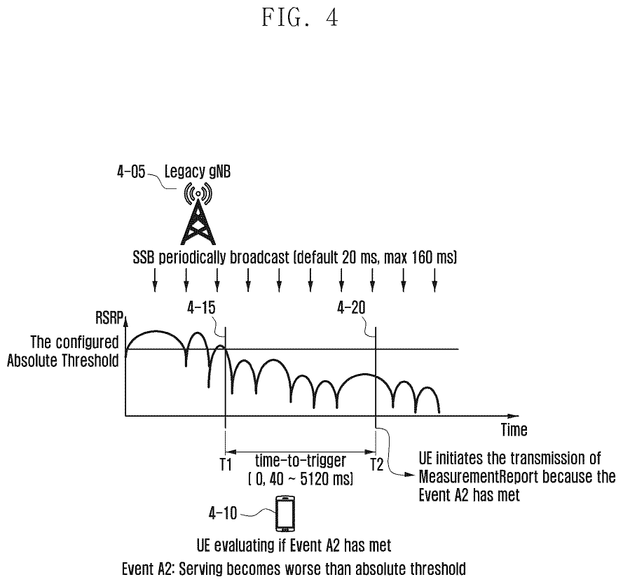

FIG. 4 is a diagram for illustrating an operation in which a UE reports a cell measurement result when a specific condition is satisfied according to an embodiment of the disclosure.

Referring to FIG. 4, a UE 4-10 may evaluate a signal strength or signal quality of a signal of a base station 4-05, based on a synchronization signal block (SSB or synchronization signal/physical broadcast channel (SS/PBCH) block) or a channel state information reference signal (CSI-RS) transmitted from the base station 4-05. Hereinafter, for convenience of description, a cell measurement result reporting operation of the UE 4-10 is described based on SSB, but the same may be applied to CSI-RS.

According to an embodiment of the disclosure, in the case of SSB, an SSB transmission period may be determined according to a configuration of the base station 4-05. For example, the SSB transmission period may be configured to be 20 ms, and the base station 4-05 may transmit an SSB with a period of up to 160 ms.

According to an embodiment of the disclosure, when the base station 4-05 configures event A2 for the UE 4-10, the UE 4-10 may evaluate, for a predetermined time period (time-to-trigger (TTT)) from a time 4-15 when a reference signal received power (RSRP) value measured based on the SSB becomes lower than a configured absolute threshold value, whether the RSRP value measured based on the SSB is continuously lower than the threshold.

According to an embodiment of the disclosure, if an RSRP value measured from the initial time 4-15 when the RSRP value measured based on the SSB becomes lower than the configured absolute threshold value to a time 4-20 when the predetermined time-to-trigger (TTT) has elapsed is continuously lower than the threshold, the UE 4-10 may consider that event A2 is satisfied and report a measurement report triggered by event A2 to the base station 4-05. As described above, by considering the TTT when determining whether a condition for performing measurement reporting are satisfied, variability of a measurement signal may be compensated. The TTT value may be configured for each event by the base station 4-05 for the UE 4-10.

According to an embodiment of the disclosure, if events continuously satisfy predetermined conditions for the predetermined time period (TTT), the UE 4-10 may perform operations corresponding to purposes of the events according to the configured purposes of the configured event. For example, if a measurement reporting type according to measurement-related configuration information received by the UE 4-10 is configured to be “periodical” or “event-triggered periodical,” the UE 4-10 may perform measurement reporting periodically.

According to an embodiment of the disclosure, with an existing layer 3 (L3) handover mechanism, a handover may be triggered and executed by a network or a base station, based on history cell measurement results and/or cell measurement event(s) reported in the past. In other words, this may be understood as a kind of a reactive scheme.

The reactive handover scheme may be efficient for existing services when a UE moves between macro cells or when a UE has low mobility. On the other hand, the reactive handover scheme may be problematic when a U E has high mobility or when a UE moves between high-density micro cells, or for future services, such as XR. For example, unintended situations, such as a handover failure, a radio link failure, a ping-pong phenomenon, a throughput loss, or an excessively early/late handover, may occur.

Accordingly, conditional handover has been introduced in Rel-16 to improve handover robustness, and lower-layer triggered mobility (LTM) handover has been introduced in Rel-18 to reduce service interruption time caused by frequent handover between small cells. However, these two handover mechanisms (conditional handover and LTM) are still based on the reactive scheme, and therefore may not be sufficient.

On the other hand, a handover mechanism based on an artificial intelligence and machine learning (AI/ML) model may enable a proactive scheme. For example, a UE may generate predicted cell measurement information for the future via the AI/ML model, and may report the predicted cell measurement information for the future, which is generated via the AI/ML model, to a base station (or network). Based on this, the base station may be able to prepare for a handover in advance to prevent a delay and preemptively indicate the UE to perform a handover, thereby allowing the UE to handover to another base station or cell before a problem (e.g., a radio link failure (RLF)) occurs to the UE. In addition, by receiving predicted cell measurement information regarding the future of the UE, the base station may achieve improved handover and/or radio resource management (RRM) performance compared to the reactive scheme. For example, the base station may make better network operation/configuration determinations or take proactive measures to avoid an unintended event. Alternatively, the base station or network may generate prediction information by running an AI model (e.g., machine learning or deep learning) by using report information received from the UE, and the base station or network may preemptively indicate the UE to perform a handover by using the generated prediction information.

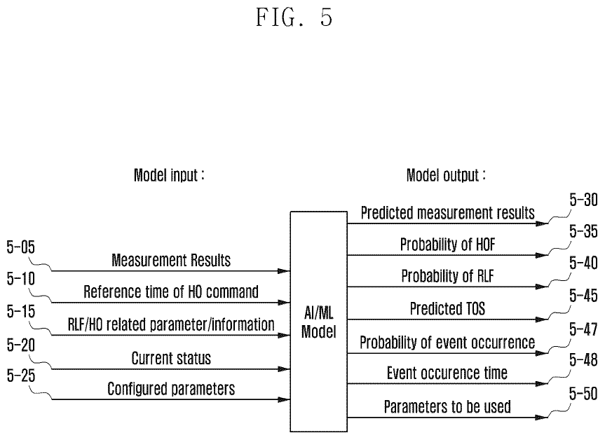

FIG. 5 is a diagram illustrating input information (Input) and output information (Output) of an artificial intelligence model used by a UE according to an embodiment of the disclosure.

Referring to FIG. 5, in operation 5-05, a UE may use, as input information of an AI model, layer 3 (L3) and/or layer 1 (L1) measurement information (e.g., measurement cell information, measurement time information, a measured RSRP value, a measured RSRQ value, and a measured SINR value) (from the past to the present or the present) for a serving cell and/or a neighboring cell. The measurement value information may be a cell-level or beam-level measurement value.

In operation 5-10, the UE may use a reference time or a predicted time (T) as input information of the AI model. The reference time may indicate a specific time period in the future. In an embodiment of the disclosure, the UE may use a reference time period or a predicted time period (T) as input information of the AI model. The reference time period may indicate a specific time period in the future.

In an embodiment of the disclosure, when predicting/deriving a cell measurement value (e.g., a cell-level or beam-level RSRP, RSRQ, SINR, or CQI) as an output, the AI model of the UE may derive a cell measurement value (e.g., a cell-level or beam-level RSRP, RSRQ, SINR, or CQI) predicted at a time (or in a time period) (T) indicated by the input reference time (or reference time period).

In an embodiment of the disclosure, when predicting/deriving a handover failure (HOF) probability as an output, the AI model of the UE may derive an HOF probability predicted at a time (T) indicated by the input reference time. For example, the derived HOF probability may indicate at least one of the followings.

For example, the HOF probability may indicate a probability that the UE is unable to complete a handover (e.g., unable to complete RRC ReconfigurationComplete message transmission) to a target cell (e.g., within a fixed or configured time period) when it is assumed that the UE receives a handover command (e.g., an RRC Reconfiguration message including reconfigurationWithSync) (e.g., at the reference time (or in the reference time period) T).

The HOF probability according to an embodiment of the disclosure may indicate at least one of probabilities that, when or before and/or after the UE receives a handover command (e.g., at the reference time (or in the reference time period) T), (e.g., within a fixed or configured time period): 1) the UE detects or declares an RLF; 2) timer T304 expires; 3) timer T311 expires; 4) timer T310 expires; 5) timer T312 expires; 6) (X consecutive) out-of-sync indicators are received (e.g., in L3) from layer 1 (L1); 7) timer T310, T311, or T312 is running or has started running; and/or 8) an RSRP, RSRQ, SINR, or CQI for a source cell or a target cell or for a beam of a corresponding cell is equal to or lower than a specific threshold value (for a predetermined period of time).

The HOF probability according to an embodiment of the disclosure may indicate at least one of probabilities that, after the UE receives a handover command (e.g., at the reference time (or in the reference time period) T) and then successfully performs a handover (e.g., after successfully completing RRC ReconfigurationComplete message transmission) to a target cell, (e.g., within a fixed or configured time period): 1) the UE detects or declares an RLF; 2) timer T304 expires; 3) timer T311 expires; 4) timer T310 expires; 5) timer T312 expires; and/or 6) (X consecutive) out-of-sync indicators are received (e.g., in L3) from layer 1 (L1).

In an embodiment of the disclosure, when predicting/deriving a radio link failure (RLF) probability as an output, the UE may derive an RLF probability predicted at a time (or in a time period) (T) (e.g., indicated by the input reference time (or reference time period)).

For example, the RLF probability may indicate at least one of probabilities that (e.g., at the reference time (or in the reference time period) T or within a time period fixed or configured based on T): 1) the UE detects or declares an RLF; 2) timer T304 expires; 3) timer T311 expires; 4) timer T310 expires; 5) timer T312 expires; 6) (X consecutive) out-of-sync indicators are received (e.g., in L3) from layer 1 (L1); 7) timer T310, T311, or T312 is running or has started running; and/or 8) an RSRP, RSRQ, SINR, or CQI for a related cell or beam cell is equal to or lower than a specific threshold value (for a predetermined period of time).

In an embodiment of the disclosure, when predicting/deriving, as an output, occurrence of a handover failure (HOF) or whether an HOF has occurred, the AI model of the UE may derive occurrence of an HOF or whether an HOF has occurred, which is predicted at a time (T) indicated by the input reference time. For example, the occurrence of an HOF may indicate at least one of the followings.

For example, the occurrence of an HOF may indicate a case where the U E is unable to complete a handover (e.g., unable to complete RRC ReconfigurationComplete message transmission) to a target cell (e.g., within a fixed or configured time period) when it is assumed that the UE receives a handover command (e.g., an RRC Reconfiguration message including reconfigurationWithSync) (e.g., at the reference time (or in the reference time period) T).

The occurrence of an HOF or whether an HOF has occurred according to an embodiment of the disclosure may indicate at least one of cases where, when or before and/or after the UE receives a handover command from the base station (e.g., at the reference time (or in the reference time period) T), (e.g., within a fixed or configured time period): 1) the UE detects or declares an RLF; 2) timer T304 expires; 3) timer T311 expires; 4) timer T310 expires; 5) timer T312 expires; 6) (X consecutive) out-of-sync indicators are received (e.g., in L3) from layer 1 (L1); 7) timer T310, T311, or T312 is running or has started running; and/or 8) an RSRP, RSRQ, SINR, or CQI for a source cell or a target cell or for a beam of a corresponding cell is equal to or lower than a specific threshold value (for a predetermined period of time).

The occurrence of an HOF according to an embodiment of the disclosure may indicate at least one of cases where, after the UE receives a handover command from the base station (e.g., at the reference time (or in the reference time period) T) and then successfully performs a handover (e.g., after successfully completing RRC ReconfigurationComplete message transmission) to a target cell, (e.g., within a fixed or configured time period): 1) the UE detects or declares an RLF; 2) timer T304 expires; 3) timer T311 expires; 4) timer T310 expires; 5) timer T312 expires; and/or 6) (X consecutive) out-of-sync indicators are received (e.g., in L3) from layer 1 (L1).

In an embodiment of the disclosure, when predicting/deriving, as an output, occurrence of a radio link failure (RLF) or whether an RLF occurs, the UE may derive occurrence of an RLF or whether an RLF occurs, which is predicted at a time (or in a time period) (T) (e.g., indicated by the input reference time (or reference time period)).

For example, the occurrence of an RLF may indicate at least one of cases that (e.g., at the reference time (or in the reference time period) T or within a time period fixed or configured based on T): 1) the UE detects or declares the RLF; 2) timer T304 expires; 3) timer T311 expires; 4) timer T310 expires; 5) timer T312 expires; 6) (X consecutive) out-of-sync indicators are received (e.g., in L3) from layer 1 (L1); 7) timer T310, T311, or T312 is running or has started running; and/or 8) an RSRP, RSRQ, SINR, or CQI for a related cell or beam cell is equal to or lower than a specific threshold value (for a predetermined period of time).

In an embodiment of the disclosure, when predicting/deriving a time of stay (TOS, a time staying in a connected cell) as an output, the UE may derive a TOS value predicted at a time (or in a time period) (T) (e.g., indicated by the input reference time (or reference time period)).

For example, the TOS value may indicate at least one of times until, after the UE receives a handover command (e.g., at the reference time (or in the reference time period) T), completes a handover (e.g., at the reference time (or in the reference time period) T), or transitions to a connected mode (connected to a new cell) (e.g., at the reference time T), (e.g., within a fixed or configured time period): 1) the UE detects or declares an RLF; 2) timer T304 expires; 3) timer T311 expires; 4) timer T310 expires; 5) timer T312 expires; 6) (X consecutive) out-of-sync indicators are received (e.g., in L3) from layer 1 (L1); 7) a command to handover to another cell is received; 8) a handover to another cell is completed; and/or 9) the UE transitions to an inactive or standby mode.

In an embodiment of the disclosure, when predicting/deriving a probability of a specific event (e.g., event A3, event X′, RLF, or HOF) as an output, the UE may derive an event occurrence probability predicted at a time (or in a time period) (T) (e.g., indicated by the input reference time (or reference time period)).

In an embodiment of the disclosure, when predicting/deriving, as an output, occurrence of a specific event (e.g., event A3, event X′, RLF, or HOF) or whether a specific event occurs, the UE may derive an event occurrence or whether an event occurs, which is predicted at a time (or in a time period) (T) (e.g., indicated by the input reference time (or reference time period)).

In an embodiment of the disclosure, when predicting/deriving, as an output, an occurrence time or time period of a specific event (e.g., event A3 or event X′), RLF, or HOF, the UE may derive an occurrence time or time period predicted at a time (or in a time period) (T) (e.g., indicated by the input reference time (or reference time period)).

In an embodiment of the disclosure, when predicting/deriving, as an output, a network configuration parameter (e.g., an RRC parameter) to be used in the future, the UE may derive an optimal (or appropriate or recommended) network configuration parameter (e.g., an RRC parameter) predicted at a time (or in a time period) (T) (e.g., indicated by the input reference time (or reference time period)).

In operation 5-15, the UE may use, as input information of the AI model, at least one of RLF or handover-related timer configuration information and/or history (e.g., timer length and/or expiration history for timers T304, T310, T311, and T312) (from the past to the present or the present), RLF or handover-related counter value (e.g., N310 and N311) information and history (from the past to the present or the present), RLF report-related (e.g., RLF-Report) information and/or history (from the past to the present or the present), successful handover (HO) report (e.g., SuccessHO-Report)-related information and/or history (from the past to the present or the present), random-access (RA) report (e.g., RA-Report)-related information and/or history (from the past to the present or the present), and/or connection establishment failure (CEF) report (e.g., ConnEstFailReport)-related information and/or history (from the past to the present or the present).

In operation 5-20, the UE may use status information of the UE (from the past to the present or the present) as input information of the AI model.

For example, the status information of the UE may include at least one of remaining power (e.g., battery level) information of the UE, whether the UE is charged, location information of the UE, a moving speed of the UE, moving path information of the UE, pose and direction information of the UE, manufacturer and/or model information of the UE, hardware (e.g., a RAM, a CPU, a GPU, a graphic card, and memory)-related information (e.g., performance) of the UE, parameter information (e.g., an event configuration value, a time-to-trigger (TTT) length configuration value, a timer length configuration value, a timer configured for the UE, or a TTT type, etc.) configured for the UE, or configuration-related information (e.g., e.g., a type of a timer or TTT operated by the UE, whether the timer or TTT has started, information on time elapsed after the timer or TTT has started, information on time remaining until the timer expires, or information on time remaining until the TTT ends) that the UE stores, maintains, and/or manages.

In operation 5-25, the UE may use configuration parameter information (from the past to the present or the present) as input information of the AI/ML model.

For example, the configuration parameter information may include at least one piece of information among configuration information and parameter values for each layer (e.g., RRC, SDAP, PDCP, RLC, MAC, or PHY) configured from the base station or the network, or configuration information and parameter values configured by an AMF via NAS signaling.

In operation 5-30, the UE may predict/derive, as output information of the AI model, at least one piece of layer 3 (L3) and/or layer 1 (L1) measurement information (e.g., measurement cell information, measurement time information, a measured RSRP value, a measured RSRQ value, and a measured SINR value) for a serving cell and/or a neighboring cell, which is predicted at a future time. The predicted value may be a predicted value for cell-level or beam-level measurement.

In operation 5-35, the UE may predict/derive the aforementioned HOF probability (e.g., an HOF probability for each cell) as output information of the AI model.

In operation 5-40, the UE may predict/derive the aforementioned RLF probability (e.g., an RLF probability for each cell) as output information of the AI model.

In operation 5-45, the UE may predict/derive the aforementioned TOS value (e.g., a TOS value for each cell) as output information of the AI model.

In operation 5-47, the UE may predict/derive the aforementioned probability of the specific event (e.g., event A3, event X′, RLF, or HOF) as output information of the AI model.

In operation 5-48, the UE may predict/derive, as output information of the AI model, the aforementioned occurrence time or time period of the specific event (e.g., event A3 or event X′), RLF, or HOF.

In an embodiment of the disclosure, the UE may predict/derive, as output information of the AI model, the aforementioned occurrence of the specific event (e.g., event A3 or event X′), RLF, or HOF or whether the specific event occurs.

In operation 5-50, the UE may derive, as output information of the AI model, parameter information (e.g., configuration parameter information) that may be used at a future time or a value derivation time.

For example, the UE may use derived values instead of the configuration information and parameter values for each layer (e.g., RRC, SDAP, PDCP, RLC, MAC, or PHY) configured from the base station or the network, or the configuration information and parameter values configured by the AMF via NAS signaling.

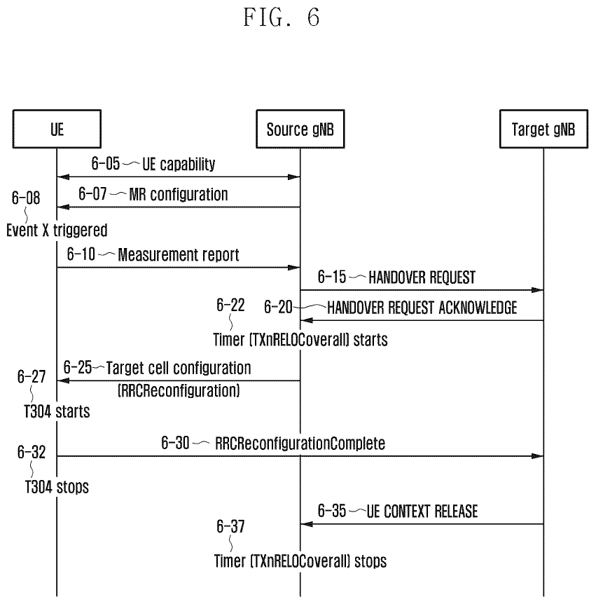

FIG. 6 is a diagram illustrating a process for performing a handover between a UE and a base station according to an embodiment of the disclosure.

Referring to FIG. 6, in operation 6-05, a base station may transmit, to a UE in a connected mode, a message (e.g., a UE capability enquiry message) for requesting transmission of support capability (e.g., capability) information. The UE having received this may transmit a message (e.g., a UE capability information message) including the support capability information of the UE to the base station. In this case, the UE capability information message may include the support capability information of the UE related to handover performance of the UE (e.g., the presence or absence of support capability).

In operation 6-07, the UE in the connected mode may receive configuration information on a cell measurement report (e.g., measurement report or MR) from the base station via a message (e.g., an RRC reconfiguration message). (e.g., this configuration information may be received via MeasConfig in the RRC Reconfiguration message). For example, the base station may provide the UE with a cell measurement report configuration associated with event X (e.g., event A1, A2, A3, A4, A5, or the like).

In operation 6-08, the UE may detect that event X has been triggered.

In operation 6-10, the UE in the connected mode may perform cell measurement according to the configuration information on the cell measurement report (e.g., measurement report or MR) and may report measurement report information generated as a result thereof to the base station via a message (e.g., a measurement report message). The report may be transmitted due to triggering of event X.

In operation 6-15, the base station or source base station may transmit, to a target base station, a message (e.g., HANDOVER REQUEST message) for requesting a handover of the UE. According to an embodiment of the disclosure, the source base station may determine to transmit the HANDOVER REQUEST message after receiving the cell measurement report received from the U E (e.g., after receiving the measurement report triggered by event A3).

In operation 6-20, the target base station having received the HANDOVER REQUEST message may transmit, to the source base station, a message (e.g., a HANDOVER REQUEST ACKNOWLEDGE message) to allow a handover of the UE. According to an embodiment of the disclosure, the HANDOVER REQUEST ACKNOWLEDGE message may include configuration information on the target cell to which the UE performs handover.

In operation 6-22, the source base station may start running timer 1 (e.g., TX nRELOCoveral) after receiving the HANDOVER REQUEST ACKNOWLEDGE message.

In operation 6-25, the source base station may indicate a handover to the target cell by transmitting target cell configuration information (e.g., including a reconfigurationWithSync configuration) to the UE via a message (e.g., an RRC reconfiguration message).

In operation 6-27, the UE may start running a timer (e.g., timer T304) after receiving the RRC reconfiguration message.

In operation 6-30, after receiving the RRC reconfiguration message including the target cell configuration information, the UE may attempt a handover to the target cell by using the configuration information. To this end, the UE may perform random access to the target cell and transmit a message (e.g., RRC reconfiguration complete message) to the target cell.

In operation 6-32, if the UE successfully completes the random access, timer T304 may be terminated. If the UE fails to successfully complete the random access, timer T304 may expire after a predetermined time, and the UE may perform an RRC re-establishment process.

In operation 6-35, the target base station may transmit, to the source base station, a message (e.g., a UE CONTEXT RELEASE (COMMAND) message) to inform the successful handover. Before transmitting the UE CONTEXT RELEASE (COMMAND) message, the target base station may exchange, with an AMF, messages (e.g., a message transmitted by the target base station to the AMF) and/or a PATH SWITCH REQUEST ACKNOWLEDGE (e.g., a message transmitted by the AMF to the target base station)), thereby changing a downlink data path and establish an NG interface.

In operation 6-37, the source base station may release the configuration information or context for the UE after receiving the UE CONTEXT RELEASE (COMMAND) message (e.g., after the successful handover). The source base station may stop timer 1 (e.g., TX nRELOCoveral) after receiving the UE CONTEXT RELEASE (COMMAND) message.

In an embodiment of the disclosure, if the UE is reconnected to the source base station or a source cell before the timer expires (e.g., before receiving the UE CONTEXT RELEASE message) (e.g., after a handover failure), the source base station may stop timer 1.

In an embodiment of the disclosure, if timer 1 expires (e.g., if the source base station has not released the configuration information or context for the UE before timer 1 expires), the source base station may release the configuration information or context for the UE.

In an embodiment of the disclosure, if timer 1 expires (e.g., if the source base station has not released the configuration information or context for the UE before timer 1 expires), the source base station may request the A M F to release U E-associated configuration and connection (UE-associated logical NG-connection) information. According to an embodiment of the disclosure, timer 1 may be a timer for the source base station and/or the AMF to release the configuration, connection, and/or context information for the UE without continuously storing the same (e.g., when the UE connects to another base station via an RRC reestablishment process after a handover failure).

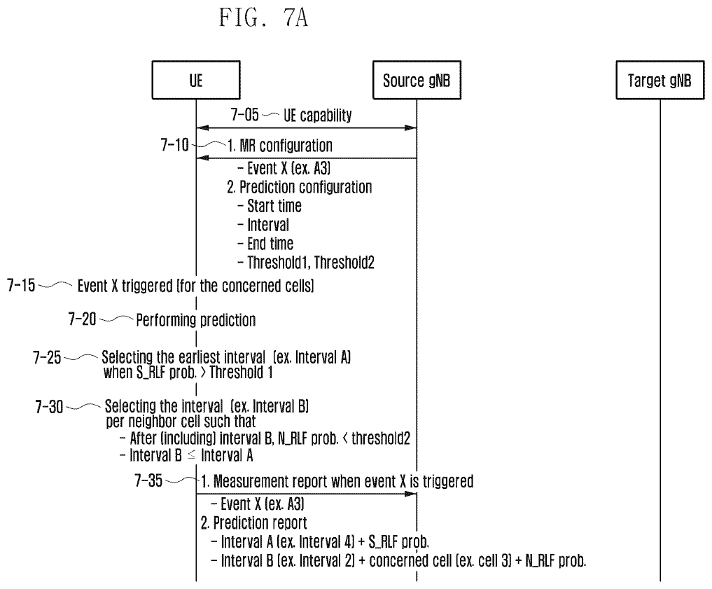

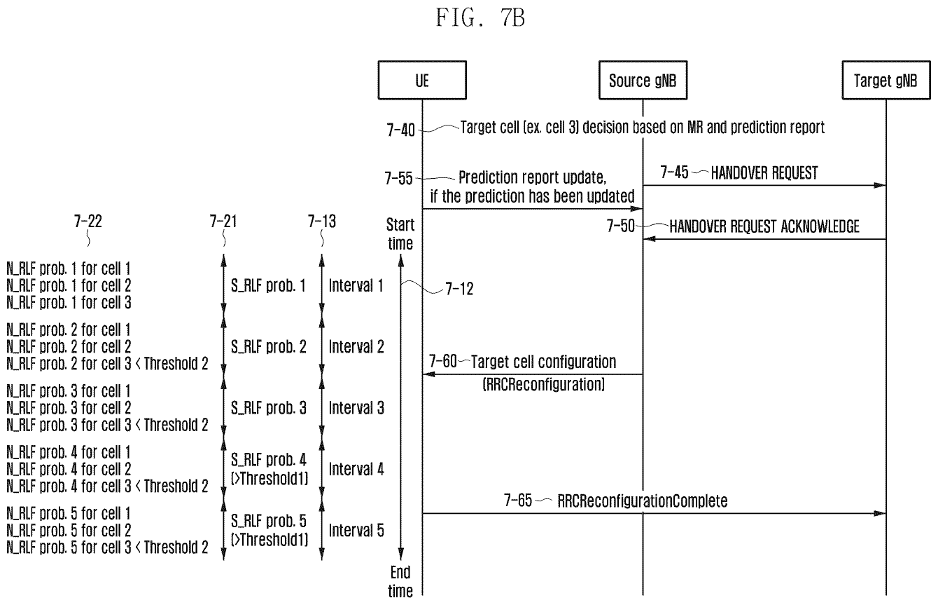

FIG. 7A is a diagram illustrating a process for performing a prediction-based handover between a UE and a base station according to an embodiment of the disclosure, and FIG. 7B is a diagram illustrating a process for performing a prediction-based handover between a UE and a base station according to an embodiment of the disclosure.

Referring to FIGS. 7A and 7B, in operation 7-05, a base station may request UE capability information from a UE (e.g., via a UE capability enquiry message), and the UE may report capability information associated with performing AI/ML-based prediction and relevant operations to the base station (e.g., via a UE capability information message). The capability information may include capability information associated with at least one of HOF prediction and/or reporting, RLF prediction and/or reporting, event prediction and/or reporting, or cell-level or beam-level measurement value prediction and/or reporting. When the capability above is supported, the UE may indicate or report support for the capability to the base station by configuring a relevant indicator to be “true” or including the relevant indicator (e.g., in the UE capability information message). On the other hand, when the capability above is not supported, the UE may indicate or report that the UE does not support the capability to the base station by configuring the relevant indicator to be “false” or omitting the relevant indicator (e.g., in the UE capability information message).

In operation 7-10, the base station may transmit a cell measurement report-related configuration to the UE (e.g., via MeasConfig in the RRC reconfiguration message). For example, the base station may provide the UE with a cell measurement report configuration associated with event X (e.g., event A1, A2, A3, A4, or A5).

In an embodiment of the disclosure, if the UE supports the AI-based prediction capability (as illustrated in 7-05), the base station may configure an AI/ML-based prediction configuration for the UE (e.g., together with or by including the cell measurement report configuration). The base station may transmit the AI/ML-based prediction configuration required for prediction. The base station may indicate, to the UE, information related to a future time (or time period) subject to prediction. For example, the prediction configuration may include at least one piece of the following information.
Information 1: a start time of a predicted period.
In an embodiment of the disclosure, this time may be indicated by an absolute time value.
In an embodiment of the disclosure, this time may be indicated by a relative time value. For example, this time may be indicated by a relative time value based on a time when the UE has transmitted a cell measurement report or prediction report (a time when the base station has received the cell measurement report or prediction report) (e.g., 7-35).
In an embodiment of the disclosure, the start time of the predicted period may not be indicated, and the time when the UE transmits (e.g., 7-35) the measurement or prediction report may be the start time of the predicted period.
Information 2: an end time of the predicted period.
In an embodiment of the disclosure, this time may be indicated by an absolute time value.
In an embodiment of the disclosure, this time may be indicated by a relative time value. For example, this time may be indicated by a relative time value based on the time when the U E has transmitted the cell measurement report or prediction report (the time when the base station has received the cell measurement report or prediction report) (e.g., 7-35).
In an embodiment of the disclosure, a length of the prediction period may be included instead of the end time.
Information 3: a length of predicted interval within the predicted period.
Information 4: an RLF probability (e.g., S_RLF prob.) threshold value (e.g., threshold value 1 or threshold 1) for a source cell.
Information 5: an RLF probability (e.g., N_RLF prob.) threshold value (e.g., threshold value 2 or threshold 2) for a neighboring cell or a candidate target cell.

The predicted period is a time period for which the UE performs prediction, and may indicate (e.g., 7-12) a future time period. According to an embodiment of the disclosure, the predicted period may include multiple predicted intervals, and the respective predicted intervals may be distinguished in the order of predicted interval 1, predicted interval 2, predicted interval 3, etc. in a time sequence (e.g., 7-13).

In operation 7-15, the UE may detect that event X is triggered.

In operation 7-20, the UE may perform AI/ML-based prediction. For example, the UE may use, as an AI/ML model input value, information configured by the base station (e.g., the start time of the predicted period, the end time of the predicted period, the length of the predicted intervals within the predicted period, or the like). For example, the UE may calculate/predict (e.g., 7-21) an RLF probability (e.g., S_RLF prob.) (for each predicted interval within the predicted period) (as an AI/ML model output value) for the source cell. For example, the UE may calculate/predict (e.g., 7-22) an RLF probability (e.g., S_RLF prob.) (for each predicted interval within the predicted period) (as an AI/ML model output value) for each neighboring cell or each neighboring cell having triggered event X. The predicted period and/or predicted interval may be information variably configured (e.g., 7-10) by the base station or may be a value or information fixed in standard documents. In an embodiment of the disclosure, after receiving a prediction configuration from the base station, the UE may perform AI/ML-based prediction using relevant configuration information. In an embodiment of the disclosure, after receiving the prediction configuration from the base station, if a predetermined condition is satisfied or a predetermined event is satisfied (e.g., 7-15), the UE may perform AI/ML-based prediction.

In operation 7-25, the UE may select a predicted interval that satisfies at least one of the following conditions.
Condition 1: a case where S_RLF prob. is greater than threshold value 1 in a corresponding predicted interval.
Condition 2: a case of an earliest predicted interval among multiple predicted intervals if the multiple predicted intervals are selected by condition 1.

The predicted interval selected by this condition may be referred to as predicted interval A (interval A). For example, for the total of five predicted intervals for the source cell, S_RLF prob. may be calculated/predicted as follows.
Predicted interval 1.
S_RLF prob. 1 (≤threshold value 1).
Predicted interval 2.
_S_RLF prob. 2 (≤threshold value 1).
Predicted interval 3.
S_RLF prob. 3 (≤threshold value 1).
Predicted interval 4.
S_RLF prob. 4 (>threshold value 1).
Predicted interval 5.
S_RLF prob. 5 (>threshold value 1).

In an embodiment of the disclosure, if the U E checks satisfaction for only condition 1, selected predicted interval A may be predicted interval 4 and/or predicted interval 5.

In an embodiment of the disclosure, if the U E checks satisfaction for both conditions (condition 1 and condition 2), selected predicted interval A may be predicted interval 4.

The UE may report 7-35 selected predicted interval A to the base station, and this may be to receive a handover indication (e.g., RRC reconfiguration message including reconfigurationWithSync, in operation 7-60) from the base station at a time earlier than the selected predicted interval. According to an embodiment of the disclosure, the base station may indicate the U E to handover to another cell at or before predicted interval A, and may cause the UE to handover to another cell before an RLF probability for the source cell becomes larger (greater than threshold value 1) (before the RLF probability becomes worse).

In operation 7-30, the UE may select a predicted interval, which satisfies at least one of the following conditions, for each neighboring cell.
Condition 1: a case where N_RLF prob. is less than threshold value 2 in the predicted interval.
Condition 2: a case where N_RLF prob. is less than threshold value 2 in all predicted intervals after the predicted interval.
Condition 3: a case where the predicted interval is a predicted interval that is same as or earlier than predicted interval A.
Condition 4: a case of an earliest predicted interval among multiple predicted intervals if the multiple predicted intervals are selected by other conditions.

In this case, the predicted interval selected for each neighboring cell may be referred to as predicted interval B (interval B).

For example, predicted interval A may be predicted interval 4, and there may be 3 neighboring cells (e.g., cell 1, cell 2, and cell 3). As a first example for this case, for cell 1, N_RLF prob. may be calculated/predicted for a total of five predicted intervals as follows.
Predicted interval 1.
N_RLF prob. 1 for cell 1 (<threshold value 2).
Predicted interval 2.
N_RLF prob. 2 for cell 1 (≥threshold value 2).
Predicted interval 3.
N_RLF prob. 3 for cell 1 (≥threshold value 2).
Predicted interval 4.
N_RLF prob. 4 for cell 1 (<threshold value 2).
Predicted interval 5.
N_RLF prob. 5 for cell 1 (<threshold value 2).

In an embodiment of the disclosure, if the UE checks satisfaction for only condition 1, predicted interval B selected for cell 1 may be predicted interval 1, predicted interval 4, and/or predicted interval 5.

In an embodiment of the disclosure, if the UE checks satisfaction for only condition 1 and condition 2, predicted interval B selected for cell 1 may be predicted interval 4 and/or predicted interval 5.

In an embodiment of the disclosure, if the UE checks satisfaction for only condition 1, condition 2, and condition 3, predicted interval B selected for cell 1 may be predicted interval 4.

In an embodiment of the disclosure, if the UE checks satisfaction only for all conditions (condition 1, condition 2, condition 3, and condition 4), predicted interval B selected for cell 1 may be predicted interval 4.

As a second example, for cell 2, N_RLF prob. may be calculated/predicted for a total of five predicted intervals as follows.
Predicted interval 1.
N_RLF prob. 1 for cell 2 (≥threshold value 2).
Predicted interval 2.
N_RLF prob. 2 for cell 2 (≥threshold value 2).
Predicted interval 3.
N_RLF prob. 3 for cell 2 (<threshold value 2).
Predicted interval 4.
N_RLF prob. 4 for cell 2 (<threshold value 2).
Predicted interval 5.
N_RLF prob. 5 for cell 2 (≥threshold value 2).

In an embodiment of the disclosure, if the U E checks satisfaction for only condition 1, predicted interval B selected for cell 2 may be predicted interval 3 and/or predicted interval 4.

In an embodiment of the disclosure, if the U E checks satisfaction for only condition 1 and condition 2, predicted interval B selected for cell 2 may not exist.

In an embodiment of the disclosure, if the UE checks satisfaction for only condition 1, condition 2, and condition 3, predicted interval B selected for cell 2 may not exist.

In an embodiment of the disclosure, if the UE checks satisfaction for all conditions (condition 1, condition 2, condition 3, and condition 4), predicted interval B selected for cell 2 may not exist.

As a third example, for cell 3, N_RLF prob. may be calculated/predicted for a total of five predicted intervals as follows.
Predicted interval 1.
N_RLF prob. 1 for cell 3 (≥threshold value 2).
Predicted interval 2.
N_RLF prob. 2 for cell 3 (<threshold value 2).
Predicted interval 3.
N_RLF prob. 3 for cell 3 (<threshold value 2).
Predicted interval 4.
N_RLF prob. 4 for cell 3 (<threshold value 2).
Predicted interval 5.
N_RLF prob. 5 for cell 3 (<threshold value 2).

In an embodiment of the disclosure, if the U E checks satisfaction for only condition 1, predicted interval B selected for cell 3 may be predicted interval 2, predicted interval 3, predicted interval 4, and/or predicted interval 5.

In an embodiment of the disclosure, if the UE checks satisfaction for only condition 1 and condition 2, predicted interval B selected for cell 3 may be predicted interval 2, predicted interval 3, predicted interval 4, and/or predicted interval 5.

In an embodiment of the disclosure, if the U E checks satisfaction for only condition 1, condition 2, and condition 3, predicted interval B selected for cell 3 may be predicted interval 2, predicted interval 3, and/or predicted interval 4.

In an embodiment of the disclosure, if the UE checks satisfaction for all conditions (condition 1, condition 2, condition 3, and condition 4), predicted interval B selected for cell 3 may be predicted interval 2.

In an embodiment of the disclosure, the UE may report 7-35 predicted interval B selected for each neighboring cell to the base station. In an embodiment of the disclosure, if the UE checks satisfaction for all conditions (condition 1, condition 2, condition 3, and condition 4) when selecting predicted interval B, the UE may report predicted interval B so as to indicate to the base station that the RLF probability predicted for the neighboring cell is lower (or better) (than threshold value 2) in predicted interval B and a subsequent predicted interval. Based on this, the base station may indicate (e.g., RRC reconfiguration message including reconfigurationWithSync, in operation 7-60) the UE to handover to the neighboring cell in predicted interval B or the subsequent predicted interval. In an embodiment of the disclosure, if the base station is reported with predicted interval A and predicted interval B (for each neighboring cell) from the UE, the base station may select one neighboring cell, and indicate the UE to handover (to the neighboring cell) at a time between predicted interval A and predicted interval B (for the neighboring cell), thereby preventing an RLF associated with the source cell before the handover indication, and preventing a handover failure (RLF with the neighboring cell) to the neighboring cell or the target cell after the handover indication.

In operation 7-35, the UE may perform cell measurement reporting (e.g., via a MeasurementReport message). For example, when configured event X (e.g., 7-10) is triggered (e.g., 7-15), a measurement result for a relevant cell may be reported. In an embodiment of the disclosure, the UE may transmit a prediction report along with the cell measurement report via the message (e.g., The MeasurementReport message). In an embodiment of the disclosure, the UE may transmit the prediction report by using a process or message separate from that for the cell measurement report. The UE may include at least one piece of the following information in the transmitted prediction report (or message).
Information 1: information on predicted interval A selected by the UE (e.g., in 7-25).
For example, a predicted interval number or identifier (ID) (e.g., 4 for predicted interval 4) and/or S_RLF prob. (e.g., S_RLF prob. 4) in the predicted interval may be indicated/included.
If the UE fails to select predicted interval A, corresponding information may be omitted.
If the number of predicted intervals A selected by the UE is N, N pieces of the information may be included.
Information 2: a predicted interval number or ID and/or S_RLF prob. in the predicted interval for each of (all) predicted intervals.
Information 3: S_RLF prob. greater than or equal to threshold value 1 and/or a corresponding predicted interval number or ID for each of (all) predicted intervals.
Information 4: information on predicted interval B selected (e.g., in 7-30) by the UE for each neighboring cell (e.g., having triggered event X).
For example, for each neighboring cell, a neighboring cell number or ID (e.g., cell 3), a number or ID (e.g., 2) of predicted interval B, and/or N_RLF prob. in predicted interval B may be indicated/included.
If N predicted intervals are selected for a single neighboring cell, N pieces of corresponding information may be included.
If the UE fails to select predicted interval B for a single neighboring cell, corresponding information may be omitted.
Information 5: a corresponding neighboring cell number or ID, corresponding predicted interval number or ID, and/or corresponding N_RLF prob. for each predicted interval and each of (all) neighboring cells (e.g., having triggered event X).
Information 6: N_RLF prob. less than or equal to threshold value 2, a corresponding neighboring cell number or ID, and/or corresponding predicted interval number or ID for each predicted interval and each of (all) neighboring cells (e.g., having triggered event X).
Information 7: source cell-related prediction information (e.g., source cell information, AI/ML model output information, information generated/derived using AI/ML model output information, an RLF probability, an HOF probability, a TOS value, a cell or beam measurement value, and information on a future time or time period subject to prediction).
Information 8: prediction information for each neighboring cell or target candidate cell (e.g., neighboring cell information, AI/ML model output information, information generated/derived using AI/ML model output information, information on an event predicted to occur, an RLF probability, an HOF probability, a TOS value, a cell or beam measurement value, information on a future time or time period subject to prediction, an RLF occurrence predicted time, an HOF occurrence predicted time, and event occurrence predicted time).
Information 9: handover (indication) time or time period information preferred by the UE or requested from the base station.
Information 10: handover (indication) target (candidate) cell information preferred by the UE or requested from the base station.

According to an embodiment of the disclosure, some information, time, or parameters illustrated in each piece of information may be omitted, and other similar configurations, etc. may be additionally included. In operation 7-40, the base station may determine a target cell based on the information included in the cell measurement report and/or prediction report transmitted by the UE, and may determine a handover indication (e.g., 7-60) timing. In an embodiment of the disclosure, the base station may transmit a handover indication before the UE has a high RLF probability associated with the source cell. In an embodiment of the disclosure, the base station may determine the handover indication timing so that an RLF probability associated with the target cell may be maintained low after the handover indication. For example, the base station may determine cell 3 as the target cell, and the base station may transmit (e.g., 7-60) the handover indication to the UE between predicted interval B (e.g., predicted interval 2) and predicted interval A (e.g., predicted period 4).

In operation 7-45, the (source) base station may transmit a handover request (e.g., a HANDOVER REQUEST message) to the target cell.

In operation 7-50, the (source) base station may receive an acknowledgment (e.g., a HANDOVER REQUEST ACKNOWLEDGE message) for the handover request, as a response to the handover request (e.g., the HANDOVER REQUEST message) transmitted to the target (candidate) cell. The HANDOVER REQUEST ACKNOWLEDGE message may include configuration information on the target cell to which the UE performs handover.

In an embodiment of the disclosure, the base station may configure (e.g., 7-10) the start time of the predicted period for the UE by considering a delay time (e.g., a time taken to perform processes of 7-35, 7-40, 7-45, 7-50, and 7-60) from the cell measurement report and/or prediction report (e.g., 7-35) to the handover indication (e.g., 7-60). For example, if it generally takes or requires time K for the base station to perform the processes from receiving the cell measurement report and/or prediction report (e.g., 7-35) to indicating the handover (e.g., 7-60), the base station may configure time K (e.g., as a relative time value) when configuring the start time of the predicted period for the UE in 7-10, and this may indicate that the predicted period starts after time K has elapsed from the UE transmitting the cell measurement report and/or prediction report (e.g., 7-35). Therefore, the base station may perform handover preparation and related processes until the handover indication (e.g., 7-60) during time K after receiving the cell measurement report and/or prediction report (e.g., 7-35).

In operation 7-55, if there is a change in the prediction information transmitted by being included in the previous prediction report (e.g., 7-35) (e.g., if the predicted/derived value has changed as a result of continuously running the AI/ML model after 7-35), the UE may update the prediction information or transmit new prediction information to the base station, and the process of operation 7-35 and related descriptions may be referenced for this operation. In an embodiment of the disclosure, the UE may transmit or update the prediction report (e.g., 7-35 or 7-55) before receiving the handover indication (e.g., 7-60) from the base station, and may not transmit or update the prediction report (e.g., 7-35 or 7-55) after receiving the handover instruction (e.g., 7-60). The base station may perform a handover process to a new cell by using the information updated in 7-55 after stopping the previous handover process (e.g., 7-45 and 7-50).

In operation 7-60, the source base station may indicate a handover to the target cell by transmitting target cell configuration information (e.g., including a reconfigurationWithSync configuration) to the UE via a message (e.g., an RRC reconfiguration message). The UE may start running a timer (e.g., timer T304) after receiving the RRC reconfiguration message.

In operation 7-65, after receiving the RRC reconfiguration message including the target cell configuration information, the UE may attempt a handover to the target cell by using the configuration information. To this end, the UE may perform random access to the target cell and transmit a message (e.g., RRC reconfiguration complete message) to the target cell. If the UE successfully completes the random access, the source base station may terminate timer T304. If the UE fails to successfully complete the random access, timer T304 may expire after a predetermined time, and the UE may perform an RRC re-establishment process.

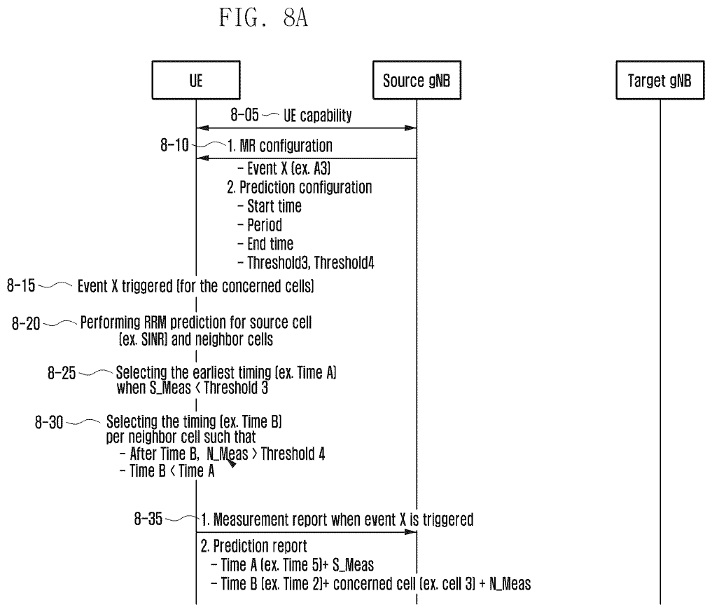

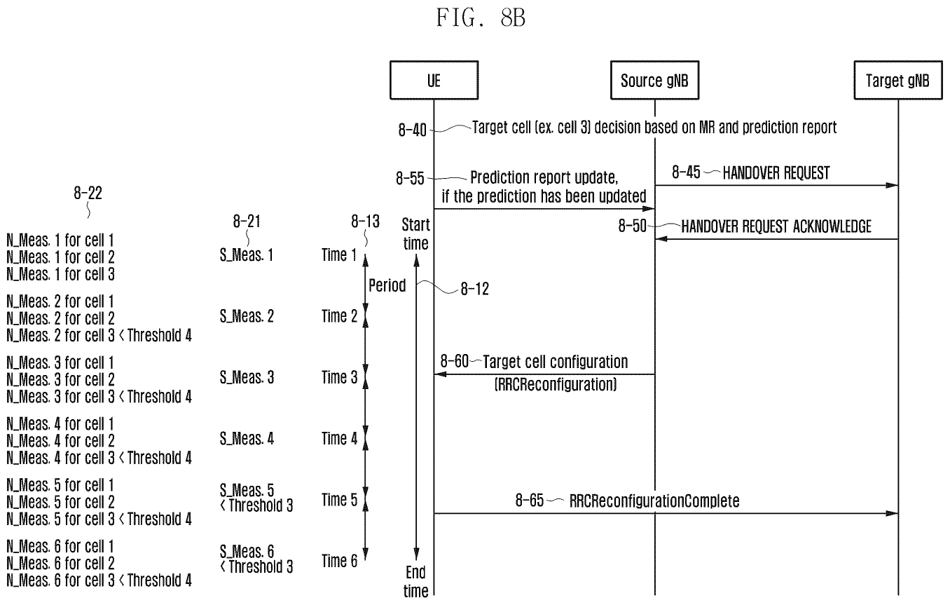

FIG. 8A is a diagram illustrating a process for performing a prediction-based handover between a UE and a base station according to an embodiment of the disclosure, and FIG. 8B is a diagram illustrating a process for performing a prediction-based handover between a UE and a base station according to an embodiment of the disclosure.

Referring to FIGS. 8A and 8B, in operation 8-05, a base station may request UE capability information from a UE (e.g., via a UE capability enquiry message), and the UE may report capability information associated with performing AI/ML-based prediction and relevant operations to the base station (e.g., via a UE capability information message). The capability information may include capability information associated with at least one of HOF prediction and/or reporting, RLF prediction and/or reporting, event prediction and/or reporting, or cell or beam unit measurement value prediction and/or reporting. When the capability above is supported, the UE may indicate or report support for the capability to the base station by configuring a relevant indicator to be “true” or including the relevant indicator (e.g., in the UE capability information message). On the other hand, when the capability above is not supported, the UE may indicate or report that the UE does not support the capability to the base station by configuring the relevant indicator to be “false” or omitting the relevant indicator (e.g., in the UE capability information message).

In operation 8-10, the base station may transmit a cell measurement report-related configuration to the UE (e.g., via MeasConfig in the RRC reconfiguration message). For example, the base station may provide the UE with a cell measurement report configuration associated with event X (e.g., event A1, A2, A3, A4, or A5).

In an embodiment of the disclosure, if the UE supports the AI-based prediction capability (as illustrated in 8-05), the base station may configure an AI/ML-based prediction configuration for the UE (e.g., together with or by including the cell measurement report configuration). The base station may transmit the AI/ML-based prediction configuration required for prediction. The base station may indicate, to the UE, information related to a future time (or time period) subject to prediction. For example, the prediction configuration may include at least one piece of the following information.
Information 1: a start time of a predicted period.
In an embodiment of the disclosure, this time may be indicated by an absolute time value.
In an embodiment of the disclosure, this time may be indicated by a relative time value. For example, this time may be indicated by a relative time value based on a time when the UE has transmitted a cell measurement report or prediction report (a time when the base station has received the cell measurement report or prediction report) (e.g., 8-35).
In an embodiment of the disclosure, the start time of the predicted period may not be indicated, and the time when the UE transmits (e.g., 8-35) the measurement or prediction report may be the start time of the predicted period.
Information 2: an end time of the predicted period.
In an embodiment of the disclosure, this time may be indicated by an absolute time value.
In an embodiment of the disclosure, this time may be indicated by a relative time value. For example, this time may be indicated by a relative time value based on the time when the U E has transmitted the cell measurement report or prediction report (the time when the base station has received the cell measurement report or prediction report) (e.g., 8-35).
In an embodiment of the disclosure, a length of the prediction period may be included instead of the end time.
Information 3: a length of prediction period within the predicted period.
In an embodiment of the disclosure, instead of the length of the prediction period, the number of predictions within the predicted period may be indicated.
Information 4: a predicted measurement value (e.g., a cell-level or beam-level RSRP, RSRQ, SINR, or CQI) and a threshold value (e.g., threshold value 3 or threshold 3) for a source cell.
Information 5: a predicted measurement value (e.g., a cell-level or beam-level RSRP, RSRQ, SINR, or CQI) and a threshold value (e.g., threshold value 4 or threshold 4) for a neighboring cell or a candidate target cell.

The predicted period is a time period for which the UE performs prediction, and may indicate (e.g., 8-12) a future time period. In an embodiment of the disclosure, the UE may calculate/derive (e.g., 8-13) a measurement value (e.g., a cell-level or beam-level RSRP, RSRQ, SINR, or CQI) at a predicted time occurring in each prediction period within the predicted period (e.g., by running the AI/ML model). For example, referring to 8-13, the UE may calculate/derive measurement values at predicted time 1 (e.g., time 1), predicted time 2 (e.g., time 2), predicted time 3 (e.g., time 3), predicted time 4 (e.g., time 4), predicted time 5 (e.g., time 5), and/or predicted time 6 (e.g., time 6). The first predicted time or predicted time 1 (e.g., time 1) may be the same as the start time of the predicted period, and the last predicted time or predicted time 6 (e.g., time 6) may be the same as the end time of the predicted period. An interval between predicted time N and predicted time N+1 may be the prediction period.

In operation 8-15, the UE may detect that event X is triggered.

In operation 8-20, the UE may perform AI/ML-based prediction. For example, the UE may use, as an AI/ML model input value, information configured by the base station (e.g., the start time of the predicted period, the end time of the predicted period, the length of the prediction period within the predicted period, or the like). For example, the UE may calculate/predict (e.g., 8-21) a measurement value (e.g., a cell-level or beam-level RSRP, RSRQ, SINR, or CQI) (e.g., S_Meas) (as an AI/ML model output value) (at the prediction period interval) (within the predicted period) for the source cell. For example, the UE may calculate/predict (e.g., 8-22) a measurement value (e.g., a cell-level or beam-level RSRP, RSRQ, SINR, or CQI) (e.g., N_Meas) (as an AI/ML model output value) (at the prediction period interval) (within the predicted period) for a neighboring cell (e.g., having triggered event X) The predicted period and/or prediction period may be information variably configured (e.g., 8-10) by the base station or may be a value or information fixed in standard documents. In an embodiment of the disclosure, after receiving a prediction configuration from the base station, the UE may perform A I/ML-based prediction using relevant configuration information. In an embodiment of the disclosure, after receiving the prediction configuration from the base station, if a predetermined condition is satisfied or a predetermined event is satisfied (e.g., 8-15), the UE may perform AI/ML-based prediction.

In operation 8-25, the UE may select a predicted time that satisfies at least one of the following conditions.
Condition 1: a case where S_Meas is less than threshold value 3 in the predicted time
Condition 2: a case of an earliest predicted time among multiple predicted times if the multiple predicted times are selected by condition 1

The predicted time selected by this condition may be referred to as predicted time A (time A). For example, for a total of six predicted times (predicted time 1, predicted time 2, predicted time 3, predicted time 4, predicted time 5, and predicted time 6) for the source cell, S_Meas may be calculated/predicted as follows.
Predicted time 1.

$$S\_Meas 1 ( \geq threshold value 3 ) .$$

Predicted time 2.

$$S\_Meas 2 ( \geq threshold value 3 ) .$$

Predicted time 3.

$$S\_Meas 3 ( \geq threshold value 3 ) .$$

Predicted time 4.

$$S\_Meas 4 ( \geq threshold value 3 ) .$$

Predicted time 5.

$$S\_Meas 5 ( < threshold value 3 ) .$$

Predicted time 6.

$$S\_Meas 6 ( < threshold value 3 ) .$$

In an embodiment of the disclosure, if the UE checks satisfaction for only condition 1, selected predicted time A may be predicted time 5 and/or predicted time 6.

In an embodiment of the disclosure, if the UE checks satisfaction for both conditions (condition 1 and condition 2), selected predicted time A may be predicted time 5.

The UE may report 8-35 selected predicted time A to the base station, and this may be to receive a handover indication (e.g., RRC reconfiguration message including reconfigurationWithSync, in operation 8-60) from the base station at a time earlier than the selected predicted time. According to an embodiment of the disclosure, the base station may indicate the UE to handover to another cell at or before predicted time A, and may cause the UE to handover to another cell before a measurement value predicted for the source cell becomes smaller (than threshold value 3) (before the measurement value becomes worse).

In operation 8-30, the UE may select a predicted time, which satisfies at least one of the following conditions, for each neighboring cell.
Condition 1: a case where N_Meas is larger than threshold value 4 in the predicted time.
Condition 2: a case where N_Meas is larger than threshold value 4 at all predicted times after the predicted time.
Condition 3: a case where the predicted time is a predicted time that is same as or earlier than predicted time A.
Condition 4: a case of an earliest predicted time among multiple predicted times if the multiple predicted times are selected by other conditions.

In this case, the predicted time selected for each neighboring cell may be referred to as predicted time B (time B).

For example, predicted time A may be predicted time 5, and there may be 3 neighboring cells (e.g., cell 1, cell 2, and cell 3). As a first example for this case, for cell 1, N_Meas may be calculated/predicted for a total of six predicted times as follows.
Predicted time 1.

$$N\_Meas 1 for cell 1 ( > threshold value 4 ) .$$

Predicted time 2.

$$N\_Meas 2 for cell 1 ( \leq threshold value 4 ) .$$

Predicted time 3.

$$N\_Meas 3 for cell 1 ( \leq threshold value 4 ) .$$

Predicted time 4.

$$N\_Meas 4 for cell 1 ( > threshold value 4 ) .$$

Predicted time 5.

$$N\_Meas 5 for cell 1 ( > threshold value 4 ) .$$

Predicted time 6.

$$N\_Meas 6 for cell 1 ( > threshold value 4 ) .$$

In an embodiment of the disclosure, if the UE checks satisfaction for only condition 1, predicted time B selected for cell 1 may be predicted time 1, predicted time 4, predicted time 5, and/or predicted time 6.

In an embodiment of the disclosure, if the U E checks satisfaction for only condition 1 and condition 2, predicted time B selected for cell 1 may be predicted time 4, predicted time 5, and/or predicted time 6.

In an embodiment of the disclosure, if the U E checks satisfaction for only condition 1, condition 2, and condition 3, predicted time B selected for cell 1 may be predicted time 4 and/or predicted time 4.

In an embodiment of the disclosure, if the U E checks satisfaction only for all conditions (condition 1, condition 2, condition 3, and condition 4), predicted time B selected for cell 1 may be predicted time 4.

As a second example, for cell 2, N_Meas may be calculated/predicted for a total of six predicted times as follows.
Predicted time 1.

$$N\_Meas 1 for cell 2 ( \leq threshold value 4 ) .$$

Predicted time 2.

$$N\_Meas 2 for cell 2 ( \leq threshold value 4 ) .$$

Predicted time 3.

$$N\_Meas 3 for cell 2 ( > threshold value 4 ) .$$

Predicted time 4.

$$N\_Meas 4 for cell 2 ( > threshold value 4 ) .$$

Predicted time 5.

$$N\_Meas 5 for cell 2 ( \leq threshold value 4 ) .$$

Predicted time 6.

$$N\_Meas 6 for cell 2 ( \leq threshold value 4 ) .$$

In an embodiment of the disclosure, if the UE checks satisfaction for only condition 1, predicted time B selected for cell 2 may be predicted time 3 and/or predicted time 4.

In an embodiment of the disclosure, if the U E checks satisfaction for only condition 1 and condition 2, predicted time B selected for cell 2 may not exist.

In an embodiment of the disclosure, if the UE checks satisfaction for only condition 1, condition 2, and condition 3, predicted time B selected for cell 2 may not exist.

In an embodiment of the disclosure, if the UE checks satisfaction for all conditions (condition 1, condition 2, condition 3, and condition 4), predicted time B selected for cell 2 may not exist.

As a third example, for cell 3, N_Meas may be calculated/predicted for a total of six predicted times as follows.
Predicted time 1.

$$N\_Meas 1 for cell 3 ( \leq threshold value 4 ) .$$

Predicted time 2.

$$N\_Meas 2 for cell 3 ( > threshold value 4 ) .$$

Predicted time 3.

$$N\_Meas 3 for cell 3 ( > threshold value 4 ) .$$

Predicted time 4.

$$N\_Meas 4 for cell 3 ( > threshold value 4 ) .$$

Predicted time 5.

$$N\_Meas 5 for cell 3 ( > threshold value 4 ) .$$

Predicted time 6.

$$N\_Meas 6 for cell 3 ( > threshold value 4 ) .$$

In an embodiment of the disclosure, if the UE checks satisfaction for only condition 1, predicted time B selected for cell 3 may be predicted time 2, predicted time 3, predicted time 4, predicted time 5, and/or predicted time 6.

In an embodiment of the disclosure, if the UE checks satisfaction for only condition 1 and condition 2, predicted time B selected for cell 3 may be predicted time 2, predicted time 3, predicted time 4, predicted time 5, and/or predicted time 6.

In an embodiment of the disclosure, if the UE checks satisfaction for only condition 1, condition 2, and condition 3, predicted time B selected for cell 3 may be predicted time 2, predicted time 3, predicted time 4, and/or predicted time 5.

In an embodiment of the disclosure, if the UE checks satisfaction for all conditions (condition 1, condition 2, condition 3, and condition 4), predicted time B selected for cell 3 may be predicted time 2.

In an embodiment of the disclosure, the UE may report 8-35 predicted time B selected for each neighboring cell to the base station. In an embodiment of the disclosure, if the UE checks satisfaction for all conditions (condition 1, condition 2, condition 3, and condition 4) when selecting predicted time B, the UE may report predicted time B so as to indicate to the base station that the N_Meas value predicted for the neighboring cell is higher (or better) (than threshold value 4) in predicted time B and a subsequent predicted time. Based on this, the base station may indicate (e.g., RRC reconfiguration message including reconfigurationWithSync, in operation 8-60) the UE to handover to the neighboring cell at predicted time B or the subsequent predicted time. In an embodiment of the disclosure, if the base station is reported with predicted time A and predicted time B (for each neighboring cell) from the UE, the base station may select one neighboring cell, and indicate the UE to handover (to the neighboring cell) at a time between predicted time A and predicted time B (for the neighboring cell), so that a high or good S_Meas value may be expected in associated with the source cell before the handover indication, and a high or good N_Meas value may be expected for the neighboring cell or target cell after the handover indication.

In operation 8-35, the UE may perform cell measurement reporting (e.g., via a MeasurementReport message). For example, when configured event X (e.g., 8-10) is triggered (e.g., 8-15), a measurement result for a relevant cell may be reported. In an embodiment of the disclosure, the UE may transmit a prediction report along with the cell measurement report via the message (e.g., The MeasurementReport message). In an embodiment of the disclosure, the UE may transmit the prediction report by using a process or message separate from that for the cell measurement report. The UE may include at least one piece of the following information in the transmitted prediction report (or message).
Information 1: information on predicted time A selected by the UE (e.g., in 8-25).
For example, a predicted time number or ID (e.g., 5 for predicted time 5) and/or S_Meas (e.g., S_Meas 5) at the predicted time may be indicated/included.
If the UE fails to select predicted time A, corresponding information may be omitted.
If the number of predicted times A selected by the UE is N, N pieces of the information may be included.
Information 2: a predicted time number or ID and/or S_Meas at the predicted time for each of (all) predicted times.
Information 3: S_Meas less than threshold value 3 and/or a corresponding predicted time number or ID for each of (all) predicted times.
Information 4: information on predicted time B selected (e.g., in 8-30) by the UE for each neighboring cell (e.g., having triggered event X).
For example, for each neighboring cell, a neighboring cell number or ID (e.g., cell 3), a number or ID (e.g., 2) of predicted time B, and/or N_Meas at predicted time B may be indicated/included.
If N predicted times are selected for a single neighboring cell, N pieces of corresponding information may be included.
If the UE fails to select predicted time B for a single neighboring cell, corresponding information may be omitted.
Information 5: a corresponding neighboring cell number or ID, corresponding predicted time number or ID, and/or corresponding N_Meas for each predicted time and each of (all) neighboring cells (e.g., having triggered event X).
Information 6: N_Meas greater than or equal to threshold value 4, a corresponding neighboring cell number or ID, and/or corresponding predicted time number or ID for each predicted time and each of (all) neighboring cells (e.g., having triggered event X).
Information 7: source cell-related prediction information (e.g., source cell information, AI/ML model output information, information generated/derived using AI/ML model output information, an RLF probability, an HOF probability, a TOS value, a cell or beam measurement value, and information on a future time or time period subject to prediction).
Information 8: prediction information for each neighboring cell or target candidate cell (e.g., neighboring cell information, AI/ML model output information, information generated/derived using AI/ML model output information, information on an event predicted to occur, an RLF probability, an HOF probability, a TOS value, a cell or beam measurement value, information on a future time or time period subject to prediction, an RLF occurrence predicted time, an HOF occurrence predicted time, and event occurrence predicted time).
Information 9: handover (indication) time or time period information preferred by the UE or requested from the base station.
Information 10: handover (indication) target (candidate) cell information preferred by the UE or requested from the base station.

According to an embodiment of the disclosure, some information, time, or parameters illustrated in each piece of information may be omitted, and other similar configurations, etc. may be additionally included.

In operation 8-40, the base station may determine a target cell based on the information included in the cell measurement report and/or prediction report transmitted by the UE, and may determine a handover indication (e.g., 8-60) timing. In an embodiment of the disclosure, the base station may transmit the handover indication to the UE before an S_Meas value associated with the source cell becomes low (worse). In an embodiment of the disclosure, the base station may determine a handover indication timing so that an N_Meas value associated with the target cell may be maintained high (good) after the handover indication. For example, the base station may determine cell 3 as the target cell, and the base station may transmit (e.g., 8-60) the handover indication to the UE between predicted time B (e.g., predicted time 2) and predicted time A (e.g., predicted period 5).

In operation 8-45, the (source) base station may transmit a handover request to the target cell (e.g., by transmitting a HANDOVER REQUEST message).

In operation 8-50, the (source) base station may receive an acknowledgment (e.g., a HANDOVER REQUEST ACKNOWLEDGE message) for the handover request, as a response to the handover request (e.g., the HANDOVER REQUEST message) transmitted to the target (candidate) cell. The HANDOVER REQUEST ACKNOWLEDGE message may include configuration information on the target cell to which the UE performs handover.

In an embodiment of the disclosure, the base station may configure (e.g., 8-10) the start time of the predicted period for the UE by considering a delay time (e.g., a time taken to perform processes of 8-35, 8-40, 8-45, 8-50, and 8-60) from the cell measurement report and/or prediction report (e.g., 8-35) to the handover indication (e.g., 8-60). For example, if it generally takes or requires time K for the base station to perform the processes from receiving the cell measurement report and/or prediction report (e.g., 8-35) to indicating the handover (e.g., 8-60), the base station may configure time K (as a relative time value) when configuring the start time of the predicted period for the UE in 8-10, and this may indicate that the predicted period starts after time K has elapsed from the UE transmitting the cell measurement report and/or prediction report (e.g., 8-35). Therefore, the base station may perform handover preparation and related processes until the handover indication (e.g., 8-60) during time K after receiving the cell measurement report and/or prediction report (e.g., 8-35).

In operation 8-55, if there is a change in the prediction information transmitted by being included in the previous prediction report (e.g., 8-35) (e.g., if the predicted/derived value has changed as a result of continuously running the AI/ML model after 8-35), the UE may update the prediction information or transmit new prediction information to the base station, and the process of operation 8-35 and related descriptions may be referenced for this operation. In an embodiment of the disclosure, the UE may transmit or update the prediction report (e.g., 8-35 or 8-55) before receiving the handover indication (e.g., 8-60) from the base station, and may not transmit or update the prediction report (e.g., 8-35 or 8-55) after receiving the handover instruction (e.g., 8-60). The base station may perform a handover process to a new cell by using the information updated in 8-55 after stopping the previous handover process (e.g., 8-45 and 8-50).

In operation 8-60, the source base station may indicate a handover to the target cell by transmitting target cell configuration information (e.g., including a reconfigurationWithSync configuration) to the UE via a message (e.g., an RRC reconfiguration message). The UE may start running a timer (e.g., timer T304) after receiving the RRC reconfiguration message.

In operation 8-65, after receiving the RRC reconfiguration message including the target cell configuration information, the UE may attempt a handover to the target cell by using the configuration information. To this end, the UE may perform random access to the target cell and transmit a message (e.g., RRC reconfiguration complete message) to the target cell. If the UE successfully completes the random access, the source base station may terminate timer T304. If the UE fails to successfully complete the random access, timer T304 may expire after a predetermined time, and the UE may perform an RRC re-establishment process.

In an embodiment of the disclosure, the UE and the base station may perform the processes of FIGS. 8A and 8B, and description for each operation may be referenced. The UE and the base station may additionally perform the following processes.

In operation 8-10, the base station may configure, for the UE, a reference time (or reference time period) in the prediction configuration. In an embodiment of the disclosure, the reference time or the start/end time of the reference time period may be indicated by an absolute time value (e.g., May 7, 2024, 15:34:30). In an embodiment of the disclosure, the reference time or the start/end time of the reference time period may be indicated by a relative time value. For example, the time may be indicated by a relative time value based on the time when the UE has transmitted the cell measurement report or prediction report (the time when the base station has received the cell measurement report or prediction report) (e.g., 8-35).

In operation 8-20, the UE may derive cell measurement values (e.g., cell-level or beam-level RSRP, RSRQ, SINR, or CQI) predicted for the source cell and the neighboring cell at a time (or in a time period) indicated by the reference time (or in the reference time period).

In operations 8-25 and 8-30, the UE may predict (via the prediction values) information on whether an RLF occurs or not for the source cell or an RLF probability at the reference time (or in the reference time period). Alternatively, the UE may predict, via the prediction values, information on whether an RLF occurs or not for each neighboring cell or target candidate cell (whether an RLF occurs for each neighboring cell) or an RLF probability at the reference time (or in the reference time period). In addition, the UE may predict, via the prediction values, information on whether an HOF occurs or not (during the handover) for each neighboring cell or target candidate cell (whether an HOF occurs for each neighboring cell) or an HOF probability at the reference time (or in the reference time period).

In operation 8-35, the UE may indicate/report to the base station whether an RLF will occur (or its probability) for the source cell, whether an RLF will occur (or its probability) for each neighboring cell, and/or whether an HOF will occur (or its probability) for each neighboring cell, which are predicted at the reference time (or in the reference time period).

For example, the UE may include indicator A in the prediction report message or configure indicator A to be “true”, thereby indicating or reporting to the base station that occurrence of an RLF for the source cell is predicted at the reference time (or in the reference time period). On the other hand, the UE may omit indicator A from the prediction report message or configure indicator A to be “false”, thereby indicating or reporting to the base station that occurrence of an RLF for the source cell is not predicted at the reference time (or in the reference time period).

For example, the UE may include indicator B for each neighboring cell in the prediction report message or configure indicator B to be “true”, thereby indicating or reporting to the base station that occurrence of an RLF for the neighboring cell is predicted at the reference time (or in the reference time period). On the other hand, the UE may omit indicator B for each neighboring cell from the prediction report message or configure indicator B to be “false”, thereby indicating or reporting to the base station that occurrence of an RLF for the neighboring cell is not predicted at the reference time (or in the reference time period).

For example, the UE may include indicator C for each neighboring cell in the prediction report message or configure indicator C to be “true”, thereby indicating or reporting to the base station that occurrence of an HOF for the neighboring cell is predicted at the reference time (or in the reference time period). On the other hand, the UE may omit indicator C for each neighboring cell from the prediction report message or configure indicator C to be “false”, thereby indicating or reporting to the base station that occurrence of an HOF for the neighboring cell is not predicted at the reference time (or in the reference time period).

In operation 8-40, the base station may determine one target cell by using the prediction report information and determine a handover indication timing to be the reference time or a time in the reference time period. In an embodiment of the disclosure, the base station may configure (e.g., 8-10) the reference time (or reference time period) for the UE by considering a delay time (e.g., a time taken to perform processes of 8-35, 8-40, 8-45, 8-50, and 8-60) from the cell measurement report and/or prediction report (e.g., 8-35) to the handover indication (e.g., 8-60). For example, if it generally takes or requires time K for the base station to perform the processes from receiving the cell measurement report and/or prediction report (e.g., 8-35) to indicating the handover (e.g., 8-60), the base station may configure time K (as a relative time value) when configuring the reference time (or reference time period) for the UE in 8-10, and this may indicate that the reference time (or reference time period) occurs after time K has elapsed from the UE transmitting the cell measurement report and/or prediction report (e.g., 8-35). Therefore, the base station may perform handover preparation and related processes until the handover indication (e.g., 8-60) during time K after receiving the cell measurement report and/or prediction report (e.g., 8-35), and then may transmit the handover indication to the UE at a time or period indicated by the reference time (or reference time period).

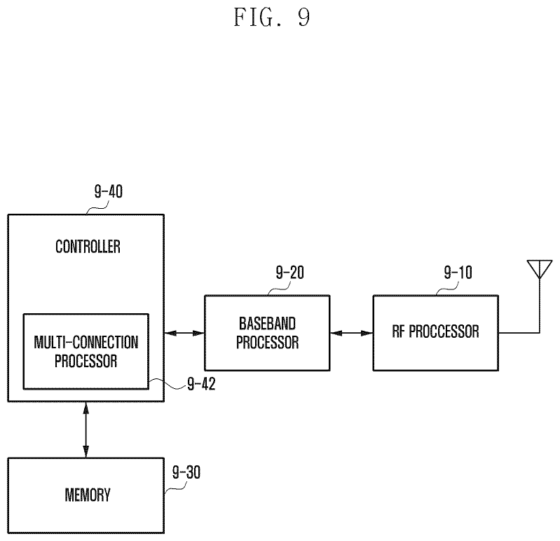

FIG. 9 illustrates a structure of a UE according to an embodiment of the disclosure.

Referring to FIG. 9, a UE according to an embodiment of the disclosure may include a radio frequency (RF) processor 9-10, a baseband processor 9-20, a storage unit 9-30, and a controller 9-40.

The RF processor 9-10 may perform a function for transmitting and receiving a signal via a wireless channel, such as band conversion and amplification of the signal. For example, the RF processing unit 9-10 may up-convert a baseband signal provided from the baseband processing unit 9-20 to an RF band signal, may transmit the same through an antenna, and may down-convert an RF band signal received through the antenna to a baseband signal. For example, the RF processor 9-10 may include a transmission filter, a reception filter, an amplifier, a mixer, an oscillator, a digital-to-analog converter (DAC), an analog-to-digital converter (ADC), and the like. Although only one antenna is illustrated in FIG. 9, the UE may include multiple antennas. In addition, the RF processor 9-10 may include multiple RF chains. Furthermore, the RF processor 9-10 may perform beamforming. For the beamforming, the RF processor 9-10 may adjust the phase and magnitude of each of signals transmitted and received through multiple antennas or antenna elements. In addition, the RF processor may perform MIMO, and may receive multiple layers when performing a MIMO operation.

The baseband processor 9-20 may perform functions of conversion between baseband signals and bitstrings according to the system's physical layer specifications. For example, during data transmission, the baseband processor 9-20 may encode and modulate a transmitted bitstring to generate complex symbols. In addition, during data reception, the baseband processor 9-20 may demodulate and decode a baseband signal provided from the RF processor 9-10 to restore a received bitstring. For example, when following the orthogonal frequency division multiplexing (OFDM) scheme, during data transmission, the baseband processor 9-20 may encode and modulate a transmitted bitstring to generate complex symbols, may map the complex symbols to subcarriers, and may configure OFDM symbols through an inverse fast Fourier transform (IFFT) operation and cyclic prefix (CP) insertion. In addition, during data reception, the baseband processor 9-20 may split a baseband signal provided from the RF processor 9-10 at the OFDM symbol level, may restore signals mapped to subcarriers through a fast Fourier transform (FFT) operation, and may restore a received bitstring through demodulation and decoding.

The baseband processor 9-20 and the RF processor 9-10 may transmit and receive signals as described above. Therefore, the baseband processor 9-20 and the RF processor 9-10 may be referred to as a transmitter, a receiver, a transceiver, or a communication unit. Furthermore, at least one of the baseband processor 9-20 and the RF processor 9-10 may include multiple communication modules to support multiple different radio access technologies. In addition, at least one of the baseband processor 9-20 and the RF processor 9-10 may include different communication modules to process signals in different frequency bands. For example, the different radio access technologies may include a wireless local area network (LAN) (e.g., institute of electrical and electronics engineers (IEEE) 802.11), a cellular network (e.g., LTE), and the like. In addition, the different frequency bands may include super high frequency (SHF) (e.g., 2 NRHz) bands and millimeter wave (mmWave) (e.g., 60 GHz) bands.

The storage 1unit 9-30 may store data, such as a basic program, an application, or configuration information for the operations of the UE. In addition, the storage unit 9-30 may provide data stored therein at the request of the controller 9-40. The storage unit 9-30 may be referred to as memory.

The controller 9-40 may control the overall operation of the UE. For example, the controller 9-40 may transmit/receive signals through the baseband processing unit 9-20 and the RF processing unit 9-10. In addition, the controller 9-40 may record data in the storage unit 9-30 and reads the data from the storage unit 9-30. To this end, the controller 9-40 may include at least one processor. For example, the controller 9-40 may include a CP that performs control for communication and an AP that controls upper layers, such as application programs, and may include a multi-connection processor 9-42 as illustrated in the drawing.

The processor 9-40 may include various processing circuits and/or multiple processors. For example, as used herein and the claims, the term “processor” may include various processing circuits including at least one processor. One or more of the at least one processor may be configured to individually and/or collectively perform the functions described herein in a distributed manner. As used herein, “a processor”, “at least one processor”, or “one or more processor” may be configured to perform various functions. However, these terms cover, without any limitation, situations where one processor performs some of the functions and any other processor(s) perform(s) the other functions and situations where a single processor may perform all the functions. In addition, the at least one processor may include a combination of processors that perform various functions among the functions set forth herein in a distributed manner. The at least one processor may execute instructions in order to implement or perform various functions.

In an embodiment of the disclosure, the at least one processor 9-40 may be a general-purpose processor, such as a CPU, an AP, or a digital signal processor (DSP), a graphics-only processor, such as a GPU or a vision processing unit (VPU), or an AI-only processor, such as an NPU. For example, if one or multiple processors are AI-only processors, the AI-only processors may be designed as hardware architecture specialized for processing of specific AI models.

Predefined operation rules or AI models may be characterized by being constructed through learning. Here, “construction through learning” may mean that predefined rules or AI models configured to perform desired characteristics (or purposes) are constructed by training a basic AI model (or deep learning model) through a learning algorithm by using multiple pieces of learning data. Such learning may be implemented by a device itself performing AI according to the disclosure or may be implemented through a separate server and/or system. Examples of the learning algorithm may include, but not limited to, supervised learning, unsupervised learning, semi-supervised learning, or reinforcement learning.

The AI model (pr deep learning model) may include multiple neural network layers. Each of the multiple neural network layers has multiple weight values, and may perform a neural network calculation through calculations between results of the previous layers and the weight values. The weight values that the multiple neural network layers have may be optimized by learning results of the AI model. For example, the multiple weight values may be updated so as to reduce or minimize loss values or cost values acquired by the AI model during learning processes. The artificial neural network may include a deep neural network (DNN), and example thereof may include, but not limited to, a convolutional neural network (CNN), a recurrent neural network (RNN), a restricted Boltzmann machine (RBM), a deep belief network (DBN), a B number or directional recurrent deep neural network (BRDNN), or a deep Q-network.

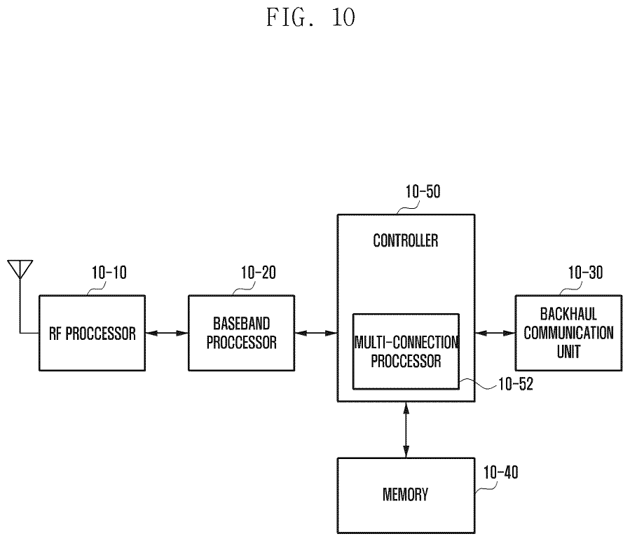

FIG. 10 illustrates a structure of a base station according to an embodiment of the disclosure.

Referring to FIG. 10, a base station according to an embodiment may include an RF processor 10-10, a baseband processor 10-20, a backhaul communication unit 10-30, a storage unit 10-40, and/or a controller 10-50.

The RF processor 10-10 may perform a function for transmitting and receiving a signal via a wireless channel, such as band conversion and amplification of the signal. For example, the RF processor 10-10 may up-convert a baseband signal provided from the baseband processor 10-20 to an RF band signal, may transmit the same through an antenna, and may down-convert an RF band signal received through the antenna to a baseband signal. For example, the RF processor 10-10 may include a transmission filter, a reception filter, an amplifier, a mixer, an oscillator, a DA C, and an ADC. Although only one antenna is illustrated in FIG. 10, the base station may include multiple antennas. In addition, the RF processor 10-10 may include multiple RF chains. Furthermore, the RF processor 10-10 may perform beamforming. For the beamforming, the RF processor 10-10 may adjust the phase and magnitude of each of signals transmitted and received through multiple antennas or antenna elements. The RF processor may transmit one or more layers to perform a downward multiple input multiple output (MIMO) operation.

The baseband processor 10-20 may perform functions of conversion between baseband signals and bitstrings according to the physical layer specifications of first radio access technology. For example, during data transmission, the baseband processor 10-20 may encode and modulate a transmitted bitstring to generate complex symbols. In addition, during data reception, the baseband processor 10-20 may demodulate and decode a baseband signal provided from the RF processor 10-10 to restore a received bitstring. For example, when following the OFDM scheme, during data transmission, the baseband processor 10-20 may encode and modulate a transmitted bitstring to generate complex symbols, may map the complex symbols to subcarriers, and may configure OFDM symbols through an IFFT operation and CP insertion. In addition, during data reception, the baseband processor 10-20 may split a baseband signal provided from the RF processor 10-10 at the OFDM symbol level, may restore signals mapped to subcarriers through FFT operation, and may restore a received bitstring through demodulation and decoding. The baseband processor 10-20 and the RF processor 10-10 may transmit and receive signals as described above. Therefore, the baseband processor 10-20 and the RF processor 10-10 may be referred to as a transmitter, a receiver, a transceiver, a communication unit, or a wireless communication unit.

The backhaul communication unit 10-30 may provide an interface for performing communication with other nodes within a network. For example, the backhaul communication unit 10-30 may convert bitstrings transmitted from the main base station to other nodes (for example, auxiliary base station, core network) to physical signals, and may convert physical signals received from the other nodes to bitstrings.

The storage unit 10-40 may store data, such as basic programs, application programs, and configuration information for the operations of the base station. More particularly, the storage unit 10-40 may store information regarding a bearer allocated to a connected UE, a measurement result reported from the connected UE, and the like. In addition, the storage unit 10-40 may store information serving as a reference to determine whether to provide multi-connection to a UE or to suspend the same. In addition, the storage unit 10-40 may provide the stored data at the request of the controller 10-50. The storage unit 10-40 may be referred to as memory.

The controller 10-50 may control the overall operation of the main base station. For example, the controller 10-50 may transmit/receive signals through the baseband processor 10-20 and the RF processor 10-10 or through the backhaul communication unit 10-30. In addition, the controller 10-50 may record data in the storage unit 10-40 and reads the data from the storage unit 10-40. To this end, the controller 10-50 may include at least one processor, and may include a multi-connection processor 10-52 as illustrated in the drawing.

The processor 10-50 may include various processing circuits and/or multiple processors. For example, as used herein and the claims, the term “processor” may include various processing circuits including at least one processor. One or more of the at least one processor may be configured to individually and/or collectively perform the functions described herein in a distributed manner. As used herein, “a processor”, “at least one processor”, or “one or more processor” may be configured to perform various functions. However, these terms cover, without any limitation, situations where one processor performs some of the functions and any other processor(s) perform(s) the other functions and situations where a single processor may perform all the functions. In addition, the at least one processor may include a combination of processors that perform various functions among the functions set forth herein in a distributed manner. The at least one processor may execute instructions in order to implement or perform various functions.

In an embodiment of the disclosure, the at least one processor 10-50 may be a general-purpose processor, such as a CPU, an AP, or a DSP, a graphics-only processor, such as a GPU or a VPU, or an AI-only processor, such as an NPU. For example, if one or multiple processors are AI-only processors, the AI-only processors may be designed as hardware architecture specialized for processing of specific AI models.

Predefined operation rules or AI models may be characterized by being constructed through learning. Here, “construction through learning” may mean that predefined rules or AI models configured to perform desired characteristics (or purposes) are constructed by training a basic AI model (or deep learning model) through a learning algorithm by using multiple pieces of learning data. Such learning may be implemented by a device itself performing AI according to the disclosure or may be implemented through a separate server and/or system. Examples of the learning algorithm may include, but not limited to, supervised learning, unsupervised learning, semi-supervised learning, or reinforcement learning.

The AI model (pr deep learning model) may include multiple neural network layers. Each of the multiple neural network layers has multiple weight values, and may perform a neural network calculation through calculations between results of the previous layers and the weight values. The weight values that the multiple neural network layers have may be optimized by learning results of the AI model. For example, the multiple weight values may be updated so as to reduce or minimize loss values or cost values acquired by the AI model during learning processes. The artificial neural network may include a DNN, and example thereof may include, but not limited to, a CNN, a RNN, a RBM, a DBN, a BRDNN, or a deep Q-network.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented.

Also, the above respective embodiments may be employed in combination, as necessary. For example, a part of one embodiment of the disclosure may be combined with a part of another embodiment to operate a base station and a terminal. In addition, the embodiments of the disclosure may be applied to other communication systems and other variants based on the technical idea of the embodiments may also be implemented. For example, the embodiments may be applied to LTE, 5G, NR, or 6G systems. Therefore, the scope of the disclosure should not be defined as being limited to the embodiments set forth herein, but should be defined by the appended claims and equivalents thereof.

The specific example for explaining the embodiments according to the disclosure is merely a combination of the respective criteria, detailed methods, and operations, and the UE or base station may perform an artificial intelligence-based handover operation in a next-generation mobile communication system through a combination of at least two of the described various techniques. Furthermore, the handover operation may be performed through one of the above-described techniques or a combination of at least two thereof. For example, some of operations of one embodiment may be performed in combination with some of operations of another embodiment.

The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. As an example, the “non-transitory storage medium” may include a buffer in which data is temporarily stored According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store, or between two user devices (e.g., smart phones) directly. If distributed online, at least a part of the computer program product (e.g., a downloadable app) may be temporarily generated or at least temporarily stored in the machine-readable storage medium, such as memory of the manufacturer's server, a server of the application store, or a relay server.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

What is claimed is:

1. A method performed by a terminal in a wireless communication system, the method comprising:
receiving, from a base station, first information on a configuration for a prediction;
based on the first information, performing the prediction;
transmitting, to the base station, second information on the prediction; and
receiving, from the base station, third information on a target cell,
wherein the second information is used for determining a timing associated with a handover.

2. The method of claim 1,
wherein the first information includes at least one of information on a time associated with the prediction, information on at least one interval, information on at least one condition, information on a number of the prediction, or information on at least one cell, and
wherein the second information includes at least one of prediction information associated with a radio resource management (RRM), prediction information on a probability, prediction information on a parameter associated with an interval or the time, prediction information on the at least one cell, or information on the timing associated with the handover.

3. The method of claim 1, wherein the performing of the prediction comprises:
identifying whether at least one condition is satisfied; and
performing the prediction on at least one cell that satisfies the at least one condition.

4. The method of claim 1, further comprising:
transmitting, to the base station, fourth information on a capability associated with the prediction,
wherein the prediction includes an artificial intelligence (AI)/machine learning (ML) prediction.

5. A method performed by a base station in a wireless communication system, the method comprising:
transmitting, to a terminal, first information on a configuration for a prediction;
receiving, from the terminal, second information on the prediction;
based on the second information, identifying at least one of a target cell or a timing associated with a handover; and
transmitting, to the terminal, third information on the target cell,
wherein the prediction is performed by the terminal based on the first information, and
wherein the second information is used for determining the timing associated with the handover.

6. The method of claim 5,
wherein the first information includes at least one of information on a time associated with the prediction, information on at least one interval, information on at least one condition, information on a number of the prediction, or information on at least one cell, and
wherein the second information includes at least one of prediction information associated with a radio resource management (RRM), prediction information on a probability, prediction information on a parameter associated with an interval or the time, prediction information on the at least one cell, or information on the timing associated with the handover.

7. The method of claim 5, further comprising:
receiving, from the terminal, fourth information on a capability associated with the prediction,
wherein the prediction includes an artificial intelligence (AI)/machine learning (ML) prediction, and
wherein the prediction is performed by the terminal on at least one cell that satisfies at least one condition.

8. A terminal in a wireless communication system, the terminal comprising:
at least one transceiver;
at least one processor communicatively coupled to the at least one transceiver; and
at least one memory, communicatively coupled to the at least one processor, storing instructions executable by the at least one processor individually or in any combination to cause the terminal to:
receive, from a base station, first information on a configuration for a prediction,
based on the first information, perform the prediction,
transmit, to the base station, second information on the prediction, and
receive, from the base station, third information on a target cell,
wherein the second information is used for determining a timing associated with a handover.

9. The terminal of claim 8,
wherein the first information includes at least one of information on a time associated with the prediction, information on at least one interval, information on at least one condition, information on a number of the prediction, or information on at least one cell, and
wherein the second information includes at least one of prediction information associated with a radio resource management (RRM), prediction information on a probability, prediction information on a parameter associated with an interval or the time, prediction information on the at least one cell, or information on the timing associated with the handover.

10. The terminal of claim 8, wherein the instructions executable by the at least one processor individually or in any combination further cause the terminal to:
identify whether at least one condition is satisfied, and
perform the prediction on at least one cell that satisfies the at least one condition.

11. The terminal of claim 8,
wherein the instructions executable by the at least one processor individually or in any combination further cause the terminal to:
transmit, to the base station, fourth information on a capability associated with the prediction, and
wherein the prediction includes an artificial intelligence (AI)/machine learning (ML) prediction.

12. A base station in a wireless communication system, the base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
transmit, to a terminal, first information on a configuration for a prediction,
receive, from the terminal, second information on the prediction,
based on the second information, identify at least one of a target cell or a timing associated with a handover, and
transmit, to the terminal, third information on the target cell,
wherein the prediction is performed by the terminal based on the first information, and
wherein the second information is used for determining the timing associated with the handover.

13. The base station of claim 12,
wherein the first information includes at least one of information on a time associated with the prediction, information on at least one interval, information on at least one condition, information on a number of the prediction, or information on at least one cell, and
wherein the second information includes at least one of prediction information associated with a radio resource management (RRM), prediction information on a probability, prediction information on a parameter associated with an interval or the time, prediction information on the at least one cell, or information on the timing associated with the handover.

14. The base station of claim 12, wherein the prediction is performed by the terminal on at least one cell that satisfies at least one condition.

15. The base station of claim 12,
wherein the instructions executable by the at least one processor individually or in any combination further cause the base station to:
receive, from the terminal, fourth information on a capability associated with the prediction, and
wherein the prediction includes an artificial intelligence (AI)/machine learning (ML) prediction.
